(19) United States
(12) Patent Application Publication
(10) Pub. No.: US 2024/0386380 A1
(43) Pub. Date: Nov. 21, 2024

(54) SYSTEMS AND METHODS FOR DIGITIZATION SERVICES

(71) Applicant: Bank of Montreal, Toronto (CA)

(72) Inventors: Zbigniew Przada, Toronto (CA); Jun Wang, Richmond Hill (CA); Ching Wan, Toronto (CA)

(21) Appl. No.: 18/674,158

(22) Filed: May 24, 2024

Related U.S. Application Data
(63) Continuation-in-part of application No. 16/517,364, filed on Jul. 19, 2019, now Pat. No. 11,995,130.
(60) Provisional application No. 62/700,394, filed on Jul. 19, 2018.

(51) Int. Cl. G06Q 10/10; G06V 30/32; H04N 1/00

(52) U.S. Cl. CPC G06Q 10/103; G06V 30/32; H04N 1/00225; H04N 1/00244; H04N 2201/0094

(57) ABSTRACT

Embodiments relate to systems and processes for digital document services, having at least a processor and a non-transient data memory storage, the data memory storage containing machine-readable instructions for execution by the processor, the machine-readable instructions configured to, when executed by the processor, provide a document service. The document service can extract data from a plurality of source systems; load and store the data at a data hub implemented by a non-transient data store; receive a request to generate a document package at the data hub, the request indicating a target unit; generate and store the document package using a subset of data from the data at the data hub, the document package having at least one electronic signature request; detect a signature event at the data hub; and transmit the document package to the target unit.

### CROSS REFERENCE TO RELATED APPLICATION

This application is a continuation-in-part of U.S. application Ser. No. 16/517,364, entitled SYSTEMS AND METHODS FOR DIGITIZATION SERVICES, filed Jul. 19, 2019, which claims priority to U.S. Provisional Application No. 62/700,394, entitled SYSTEMS AND METHODS FOR DIGITIZATION SERVICES, filed Jul. 19, 2018, which applications are hereby incorporated by reference in their entirety. This application relates to U.S. application Ser. No. 16/517,253, entitled SYSTEMS AND METHODS FOR DATA STORAGE AND PROCESSING, the contents of which is hereby incorporated by reference.

### FIELD

The present disclosure generally relates to the field of data storage systems and processing.

### INTRODUCTION

A full-service financial service institution depends heavily on the use of technology to serve customers with a wide range of products and services. In addition, technology is used to meet stringent risk management and regulatory compliance.

An organization with a long history typically has adopted a myriad range of technologies from legacy platforms like mainframe to modern capabilities like mobile and analytic applications. An organization might have a large set of applications (many hundreds) through acquisition and integration.

To continue to deliver differentiating customer experience and transformation to keep pace or leap-frog competitors, both traditional and disruptive ones, an institution needs to be able to effectively and efficiently integrate the complex and diverse set of applications. An integrated enterprise not only forms the foundational capability to deliver any product and service across different channels, it also enables the ability to identify events and generates actionable insights to become an intelligent institution.

### SUMMARY

Embodiments described herein relate to digitization and document management.

For example, this can involve capturing or scanning physical documents and performing recognition operations (to capture data form the document) for conversion into electronic documents to be properly cataloged and filed into the enterprise document repository for subsequent search and retrieval. In addition, documents associated with a specific business function (e.g., mortgage application may require multiple different documents) are automated tracked as a document package throughout its lifecycle, which is often integrated through a business process management (BPM) application that forms a repeatable and reusable business process pattern. This is an example business process pattern that can be used for Branch Scanning. Another example process pattern can be for Retail Branch service and product onboarding/account open process. The system can integrate the branch scanners which are informed by the document tracking services (built within a storage integration layer) to scan a document package determined by specific products/services onboarding BPM process. Such process has been reused for Wealth Management branch business. The processes can also be extended for business and commercial banking branch/office use case as well.

Systems for digitization and document management can connect with a digital library to access and update document data.

In an aspect, embodiments described herein provide a system for digital document services, comprising at least a processor and a non-transient data memory storage, the data memory storage containing machine-readable instructions for execution by the processor, the machine-readable instructions configured to, when executed by the processor, provide a document service configured to: load and store data from a plurality of source systems at a data hub implemented by a non-transient data store; define and store, at the data hub, process pattern for digitization of documents, the process pattern indicating document types; receive a request to generate a document package at the data hub, the request indicating a target unit, the request linked to the process pattern; generate and store, at the data hub, the document package using a subset of data from the data at the data hub and physical documents converted to electronic format according to the process pattern, the document package stored at the data hub for subsequent search and retrieval; and transmit the document package to the target unit.

In some embodiments, the document package is associated with a document package identifier, wherein the document services is configured to monitor the document package at the data hub, detect a document change notification, and store the change notification in association with the document package identifier as part of an audit log.

In some embodiments, the document services is configured to receive and store a modified version of the document package containing at least one electronic signature in response to at least one electronic signature request.

In some embodiments, the document services is configured to assign the document package to a user identifier having an access role, wherein prior to transmission, the document services is configured to check the access role and the target unit.

In some embodiments, the document package has at least one electronic signature request and wherein the processor can detect a signature event at the data hub and capture data from the signature event for storage as part of the document package.

In some embodiments, the document services comprises an electronic signature event listener to process the electronic signature event in real-time.

In some embodiments, the document services comprises an electronic signature event handler to receive the electronic signature events in real-time from the electronic signature event listener.

In some embodiments, the process pattern is linked to a business function, domain or application.

In some embodiments, the process pattern indicates a number of required documents for the document package.

In some embodiments, the process pattern indicates a type of required document for the document package.

In some embodiments, the processor integrates with one or more scanners to capture scanner data for the document package, the one or more scanners capturing the physical documents.

In accordance with an aspect, there is provided a system for digital document services, comprising at least a processor and a non-transient data memory storage, the data memory storage containing machine-readable instructions for execution by the processor, the machine-readable instructions configured to, when executed by the processor, provide a document service configured to: extract data from a plurality of source systems; load and store the data at a data hub implemented by a non-transient data store; receive a request to generate a document package at the data hub, the request indicating a target unit; generate and store the document package using a subset of data from the data at the data hub, the document package having at least one electronic signature request; detect a signature event at the data hub; and transmit the document package to the target unit.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A illustrates a system architecture diagram of a proprietary Information Delivery Platform (IDP) in accordance with one embodiment.

FIG. 1B is a view of components of a data storage and processing system including IDP.

FIG. 2 illustrates a schematic diagram of a digitization service platform as part of the IDP of FIG. 2 according to some embodiments.

FIGS. 3A and 3B illustrate a schematic diagram of a digitization service platform according to some embodiments.

FIGS. 4A and 4B illustrate a schematic diagram of a digitization service platform according to some embodiments.

FIGS. 5A-5C illustrate a schematic diagram of a digitization service platform according to some embodiments.

FIG. 6 illustrates a schematic diagram of a digitization service platform according to some embodiments.

FIG. 7 illustrates a schematic diagram of a digitization service platform according to some embodiments.

FIG. 8 illustrates a schematic diagram of a digitization service platform according to some embodiments.

FIGS. 9A-9C illustrate a schematic diagram of a digitization service platform according to some embodiments.

FIG. 10 illustrates a schematic diagram of a digitization service platform according to some embodiments.

FIGS. 11A and 11B illustrate a flow diagram of a digitization service platform according to some embodiments.

FIG. 12 illustrates a flow diagram of a digitization service platform according to some embodiments.

FIGS. 13A and 13B illustrate a flow diagram of a digitization service platform according to some embodiments.

FIG. 14 illustrates a schematic diagram of a digitization service platform according to some embodiments.

FIG. 15 illustrates a schematic diagram of a digitization service platform according to some embodiments.

FIG. 16 illustrates a schematic diagram of a digitization service platform according to some embodiments.

FIG. 17 illustrates an example interface of a digitization service platform according to some embodiments.

FIG. 18 illustrates a schematic diagram of a digitization service platform according to some embodiments.

FIG. 19 illustrates a schematic diagram of a digitization service platform according to some embodiments.

FIG. 20 illustrates a schematic diagram of a digitization service platform according to some embodiments.

FIG. 21 illustrates a schematic diagram of a digitization service platform according to some embodiments.

FIG. 22 illustrates a schematic diagram of a digitization service platform according to some embodiments.

FIG. 23 illustrates a schematic diagram of a digitization service platform according to some embodiments.

FIG. 24 illustrates a schematic diagram of an example architecture of a digitization service platform according to some embodiments.

FIG. 25 illustrates a schematic diagram of a digitization service platform according to some embodiments.

FIG. 26 illustrates a schematic diagram of a digitization service platform according to some embodiments.

FIG. 27 illustrates a flow diagram of a digitization service platform according to some embodiments.

FIG. 28 illustrates a schematic diagram of an example architecture of a digitization service platform according to some embodiments.

FIG. 29 illustrates a flow diagram of operations of a method for tracking digitized documents.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Within an enterprise data warehouse, there may be large volumes of data being ingested and stored; computational demands may also be high for extracting, transforming or otherwise processing the volumes of data into end target databases or end appliances. With traditional ETL techniques, there exists a number of pain points: “data silos”, which refer to data that is under control of one group or application and isolated from the rest of the organization may be common, and there may be need for replication of large volumes of data between the various appliances. In addition, computing and storage capacity are inherently coupled, and cannot be independently scaled. Data access control and security may be negatively affected.

The financial cost of data aggregation and consumption with current technology may be high, and meeting demand may become increasingly technically challenging.

Network bandwidth may also become a significant constraint for data communication between an enterprise data system and external systems, as well as in/out of the landing zone for batch data transmission for the enterprise data system.

In addition, capturing and maintaining accurate data lineage may also be challenging under the traditional approach.

There may be no “balance and control” or enterprise-level reconciliation patterns or models for data stored within a traditional enterprise data system. This may be the case if the enterprise data system serves as a book-of-reference and not a book-of-record. However, there is growing need for enterprise reconciliation/balance and control capabilities and patterns.

Improving ease of understanding of the data glossary and relationship between data/sources is needed to support self-serve data science initiatives.

The Financial Services Industry is a data driven industry. The scope, quality, cost, performance and freshness of data that has been “good enough” in the past is no longer good enough. Many critical bank processes require low cost, easy to access, reliable and consistent data. These process include but are not limited to: Anti Money Laundering Compliance, Regulatory and Compliance Reporting, Risk Management, Customer Insights, Sales Performance Management and Channel Optimization.

The Information Delivery Platform described in the embodiments herein incorporates

new technology and a new operating model that optimizes the accountabilities for data quality and a simplified approach to information management. This platform may provide information management capability to meet the rapidly increasing demand for low cost, easy to access, reliable and consistent data.

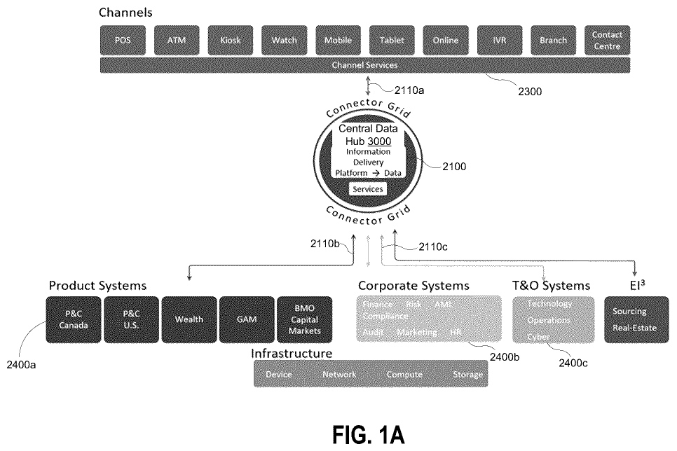

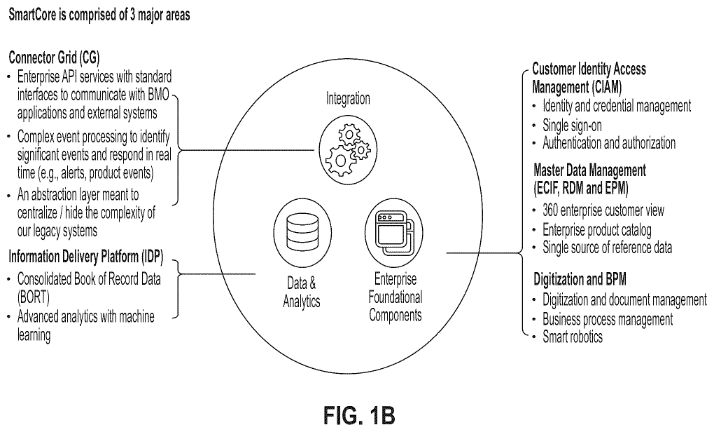

Referring now to FIG. 1A, which illustrates a system architecture diagram of an example Information Delivery Platform (IDP) 2100 with Channels 2300, Product Systems 2400a, Corporate Systems 2400b and T&O (Technology and Operation) Systems 2400c.

In an example embodiment, IDP 2100 is a data aggregation, processing, and analytics environment, combining multiple sources of data into a single organization-wide repository, and providing fast and cost-effective access to data.

In the present application, as an example, the organization is a bank. However, it should be appreciated that the organization can be any type of organization or company that requires storage and processing of data for daily operations. For example, the organization can be a government entity, a law firm, a school, a store, or a restaurant, and so on.

IDP 2100 provides more data in less time. It provides users with a high performance platform for processing queries. It has built in data quality management, high availability and disaster recovery. Its innovative operating model provides subscriber businesses a direct CIO accountability to ensure their specific needs are met. It may provide the opportunity to eliminate data sprawl by eliminating the motivations to create redundant and overlapping data marts. It may provide the following benefits: CIO accountability model means conversations about sourcing data, its content and it's quality take place directly between the owners of the source systems and the consumers of the data; high performance, cost efficient staging platform means improved query performance and lower costs for accumulating low level detail data; data quality management means problems in the source data are identified early and actively managed; consumer driven data model means the integrated database structures are presented in simple, business friendly terminology; and provides for self-serve data usage.

IDP 2100 is a shared information management component of the Analytical/Data Hub that will provision well managed data to meet multiple reporting and analytical requirements quickly and efficiently. Its innovative operating model leverages the strengths of all stakeholders and eliminates unnecessary hand offs. It is built from the ground up to meet the requirements of regulators and business process that demand on-going demonstration of data quality management and proof that the data is an accurate and complete representation of reality. It presents data to the business community using industry and bank terminology. It will provide the opportunity to eliminate data sprawl by eliminating the motivations to create redundant and overlapping data. It may provide robust, highly resilient infrastructure, DR (Disaster Recovery), high performance as most queries and loads run in a fraction of the time of existing platforms, easy tracking of data assets under management, data stewardship and data governance, data quality management and reporting capability, and data in cross application integrated (L2) model.

In an example embodiment, central data hub 3000 includes IDP 2100. In one embodiment, the IDP 2100 may include a scalable data store (also referred to as a “data lake”), which may collect and store massive amounts of data for long periods of time. The data stored may be structured, semi-structured, unstructured, or time-sensitive data (e.g. events, etc.). A central aggregation and distribution point (“book of reference”) may be generated for all book-of-record data within the bank, which provides consistent and efficient access to reference data. Both raw and processed data within the data lake may be available for consumption; powering analytics; machine learning; consumer-specific data accessible via batch, SQL, streaming, native Hadoop APIs. Linear scalability of data is also provided.

In some embodiments, IDP 2100 is connected to channel services 2300 through connector grid 2110a and connected to product systems 2400a, corporate systems 2400b and T&O systems 2400c through connector grids 2110b and 2110c.

Channel services 2300 may include internal or external interfaces adapted for different service groups, such as Point-of-Sale (POS) terminals, watch interfaces, mobile devices, tablet devices, online portals, ATMs, branches, call centers, sales forces, and so on. Each of these service group may receive and utilize data from IDP 2100 through connector grid 2110a. Each channel may have a user interface designed to display various data and information and to receive user inputs.

Across channels 2300, customer information can be captured consistently at all points of collection for all LOBs and channels, aligned to standards defined for the Enterprise Customer Domain. A single view of customer information and aggregate view of customer holdings can be displayed on channels, in real-time or near real-time, and on demand if necessary.

In addition, product systems 2400a, corporate systems 2400b and T&O systems 2400c may also receive and utilize data from IDP 2100 through connector grids 2110b, 2110c.

IDP 2100 may receive raw data from a variety of data sources. Data sources include, among others:
Book of record transaction systems (BORTS)
Clickstreams (web-logs)
Social media
Server/machine logs
Unstructured data
Real-time event streams

Raw data may be received and stored into a staging area. The staging area may be part of a “data lake” foundation from which groups across the organization can draw needed data. This staging area may be also referred to as “level 0 (L0)” data storage.

For example, when the organization is a bank, different groups may utilize data from the data lake. The groups may include: AML (Anti-Money Laundering), BCBS 239, Conditional Offer Pricing, Volcker, CCAR, FATCA, IFRS9, Stress Testing Model Development, Reg-W, Procure-to-Pay, Enterprise Customer Information (ECIF), Leads, Leads, TF, LRM/SMR, U.S. Heightened Standards, Enterprise Wire Payments, LOB (Line of Business) Scorecards, Corporate Audit Analytics, Fraud/Criminal Risk Investigation, Legacy Data Marts Simplification.

IDP 2100 may be the foundation for the overarching data environment, combining multiple sources or book of record transaction systems (BORTS) into a single organization-wide repository and provides fast and cost-effective access to both raw and conformed data.

FIG. 1B is a view of components of a data storage and processing system. The system includes an integration component, data and analytics component, and enterprise foundational components. The integration component has a connector grid. The connector grid provides enterprise API services with standard interfaces to communicate with applications and external systems. The data and analytics component has a consolidated Book of Record Data (BORT) and advanced analytics with machine learning.

The enterprise foundational components include CIAM for identity and credential management. CIAM enables single-sign on for data access with authentication and authorization. The enterprise foundational components include Master Data Management components ECIF, RDM, and EPM to provide a 360 degrees, holistic customer view of data. The Master Data Management components have an enterprise product catalog. The Master Data Management components provide a single source of reference data. The enterprise foundational components include digitization and business process management for digitization and document management with smart robotics.

IDP 2100 integrates with digital document services to define and store, at the data hub, process pattern for digitization of documents. The process patterns are re-usable. The process pattern indicate document requirements. Example requirements relate to document type or a number of documents. The digital service receives a request to generate a document package at the data hub, and the request can be linked to the process pattern. The linked process pattern defines parameters or operations and requirements for the document package. The process pattern can be liked to a business function. For example, the process pattern can indicate requirements for documents associated with a specific business function (e.g., mortgage application may require 5 different documents) so that the digitization process can be automated and a set of documents tracked as a package throughout its lifecycle, which can be integrated through a business process management (BPM) application to provide a repeatable and reusable business process pattern. The service can generate and store, at the data hub, the document package using a subset of data from the data at the data hub and physical documents converted to electronic format according to the process pattern. The document package can stored at the data hub for subsequent search and retrieval; and transmit the document package to the target unit. In some embodiments, the process pattern is linked to a business function, domain or application. In some embodiments, the process pattern indicates a number of required documents for the document package. In some embodiments, the process pattern indicates a type of required document for the document package.

The document package can be associated with a document package identifier. The document services can be configured to monitor the document package at the data hub, detect a document change notification, and store the change notification in association with the document package identifier as part of an audit log.

In some embodiments, the document services is configured to receive and store a modified version of the document package containing at least one electronic signature in response to at least one electronic signature request.

In some embodiments, the document services is configured to assign the document package to a user identifier having an access role, wherein prior to transmission, the document services is configured to check the access role and the target unit.

In some embodiments, the document package has at least one electronic signature request. The service can detect a signature event at the data hub and capture data from the signature event for storage as part of the document package.

In some embodiments, the document services comprises an electronic signature event listener to process the electronic signature event in real-time.

In some embodiments, the document services comprises an electronic signature event handler to receive the electronic signature events in real-time from the electronic signature event listener.

In some embodiments, the processor integrates with one or more scanners to capture scanner data for the document package, the one or more scanners capturing the physical documents. The scanner data can provide metadata about the capture and also quality data.

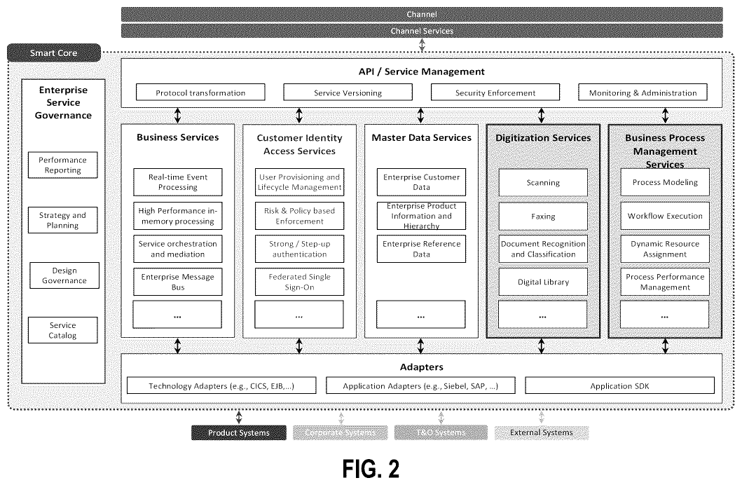

FIG. 2 is a schematic diagram of an example architecture for a digitization and BPM services platform of IDP 2100 according to some embodiments. As depicted, the platform includes an enterprise service governance unit and an API/service management unit, which connects to each of a business services unit, customer identity access services unit, master data services unit, digitization services unit, and business process management services unit, each of which connects to an adapter unit. The platform in turn connects to one or more of the following: product systems, corporate systems, technology and operations systems, and external systems. Each of these units can include the respective units as depicted.

The BPM services include process patterns to define re-usable process for generating document packages. The process patterns can indicate requirements for documents. Digitization can involve capturing or scanning physical documents and performing recognition operations (to capture data form the document) for conversion into electronic documents to be properly cataloged and filed into the enterprise document repository for subsequent search and retrieval. In addition, documents associated with a specific business function (e.g., mortgage application may require multiple different documents) are automated tracked as a document package throughout its lifecycle, which is often integrated through a business process management (BPM) application that forms a repeatable and reusable business process pattern. This is an example business process pattern that can be used for Branch Scanning. Another example process pattern can be for Retail Branch service and product onboarding/account open process. The system can integrate the branch scanners which are informed by the document tracking services (built within a storage integration layer) to scan a document package determined by specific products/services onboarding BPM process. Such process has been reused for Wealth Management branch business. The processes can also be extended for business and commercial banking branch/office use case as well.

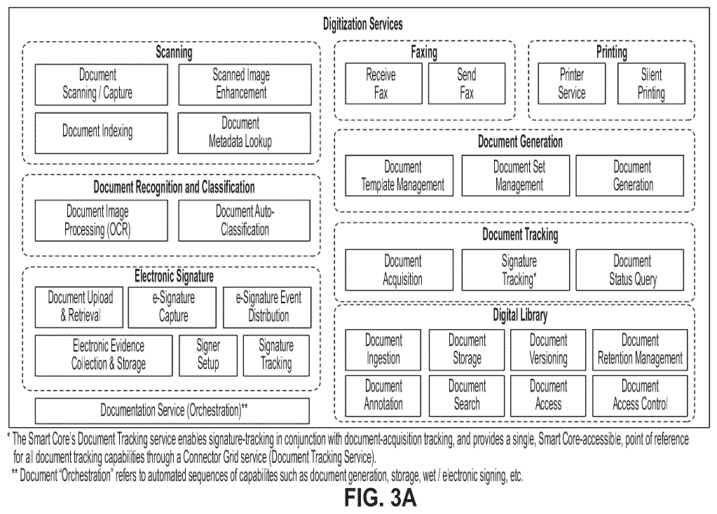

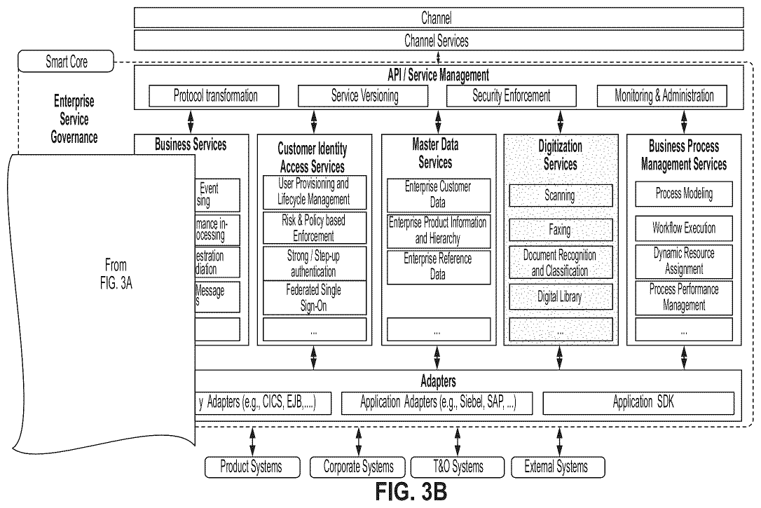

FIGS. 3A and 3B illustrate a schematic diagram of an example architecture for digitization capabilities according to some embodiments. As depicted, digitization services can include scanning units, document recognition and classification units, electronic signature units, faxing units, printing units, document generation units, document tracking units, digital library units, and documentation service (orchestration) units. The Document Tracking service enables signature-tracking in conjunction with document-acquisition tracking, and provides a single, accessible, point of reference for all document tracking capabilities through a Connector Grid service (Document Tracking Service). Document “Orchestration” refers to automated sequences of capabilities such as document generation, storage, electronic signing, etc.

As an example, in some embodiments, a digitization services platform implements an improved document scanning system, for example, usable at bank branches. The digitization services platform automatically creates document packages and tracks them including eSigning. As with other services implemented by digitization services platform, this may provide an audit trail that is as authentic, validated, and verifiable as a paper-based workflow. For example, the digitization services platform generates a form (e.g., paper or electronic) or request for initiation of a particular workflow. This may be a form that is to be physically signed by a user. The digitization services platform is then configured to scan and receive the signed form or other indicia (e.g., electronic selection) that can be used by the platform to identify a particular workflow. The digitization services platform is then configured to initiate a particular workflow, for example, by OCR of the text or contents of the signed form or the received indicia. For example, the indicia can be data indicating a mortgage application workflow is requested. The digitization services platform includes an application that generates a tracking service to track and determine the number and type of documents needed for a particular workflow. The digitization services platform may then generate the appropriate data, for example, number and type of documents needed for that workflow and can provide same to the user. The digitization services platform is configured to wait for receipt of completed or scanned versions of the completed documents and is configured to identify and wait for receipt of each and all of the documents determined to be required according to the workflow selected (e.g., mortgage application). For example, the digitization services platform may be configured to wait for seven documents of a particular type to be scanned and received before moving to the next stage of the workflow. In this example, the next stage of the workflow may be the authorization of a mortgage.

In some embodiments, each stage is performed electronically, for example, on an iPad. This can include the indication of the workflow requested, signing of documents, and providing completed documents to the digitization services platform. In each scenario in some embodiments, the digitization services platform is configured to track all the documents needed for the workflow. In some embodiments, the digitization services platform is configured to interoperate with external services such as those providing eSignature capabilities and signing ceremony functionalities. In these situations, the digitization services platform is configured to pass control to the external application for same to complete the signing ceremony and receive control back from the external application once the signing ceremony has completed.

In some embodiments, the digitization services platform includes an OCR index that can be used to tag documents with appropriate data attributes so as to be able to associate the document with particular data, for example, with identifiers of a particular mortgage application or customer. Various document types may be accepted by the digitization services platform. This provides enhanced end to end digitization service capabilities. In this way, digitization services platform is configured to track all documents received and associate same with the correct context, for example, for later retrieval. This can improve or optimize document retrieval time and allow for enhanced organization and access of documents relating to even other categorizations apart from the specific context the documents were received in. These attributes can also provide a feature set or a basis for extraction of a feature set for machine learning. Digitization services platform is configured to interconnect with a machine learning unit, for example, included as another component of the IDP that is configured to process, organize, or facilitate understanding of the data.

In some embodiments, digitization services platform is configured to provide service across an enterprise, including for different contextual environments and technical requirements associated with various lines of business, computer systems, services, channels, applications, and appliances within the enterprise. This may reduce or eliminate what would otherwise be a need for duplication of data and digitization service implementation. All channels, applications, and respective use cases may reuse these defined capabilities (e.g., form generation, rendering of a representation of a document to solicit data input from a user, etc.) of digitization services platform. For example, a particular use case (e.g., mortgage application request) for a particular channel or application may engage with a selection of these defined capabilities, with each other use cases engaging with different or the same set of defined capabilities. This may also allow for improved maintenance and update processes of any component of the digitization services platform, as same can be updated once, with the updated features of the digitization services platform provided to all applications and systems across the enterprise. In some embodiments, these changes are propagated to all or a selection of relevant channels, services, systems, and use cases.

In some embodiments, digitization services platform is configured to eliminate the need for scanning, with all documents provided, completed, signed, authenticated (e.g., identification of the user without scanning official identity documents) and received electronically, and, in some embodiments, partially or wholly in the background. Further, in some embodiments, digitization services platform is configured to improve form generation to support different configurations and use cases. An example form may be provided to a user to receive data that is used to initiate the rendering of documents flexibly to receive further input.

In some embodiments, digitization services platform is configured to generate and print a hard copy of documents, for example, copies of an agreement, at the end of the appropriate workflow.

In some embodiments, digitization services platform is integrated with risk management platforms.

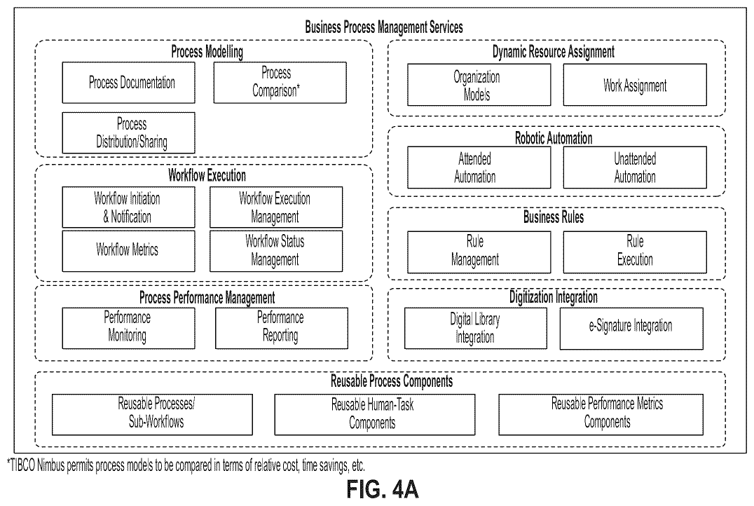

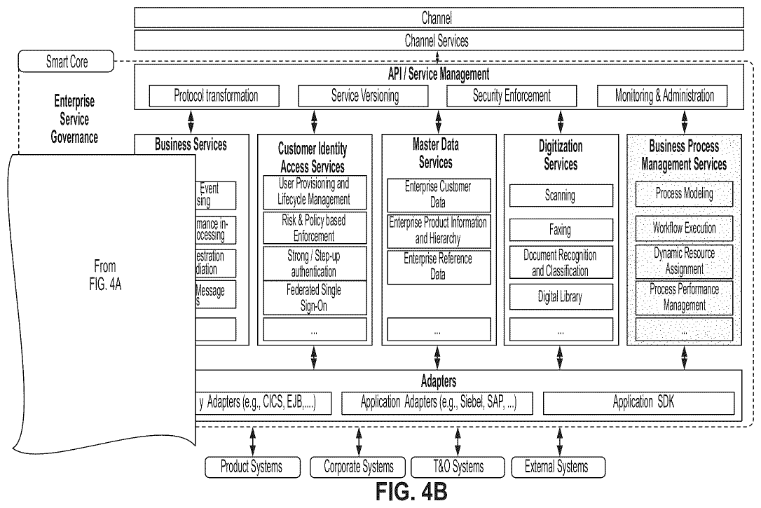

FIGS. 4A and 4B depict example business process management capabilities according to some embodiments. As depicted, the platform can include a business process management services unit, which can include a process modelling unit, workflow execution unit, process performance management unit, reusable process component units, dynamic resource assignment unit, robotic automation unit, business rules unit, and digitization integration unit, with sub-units as depicted.

Digitization services can include document generation, capture, storage, and e-signature.

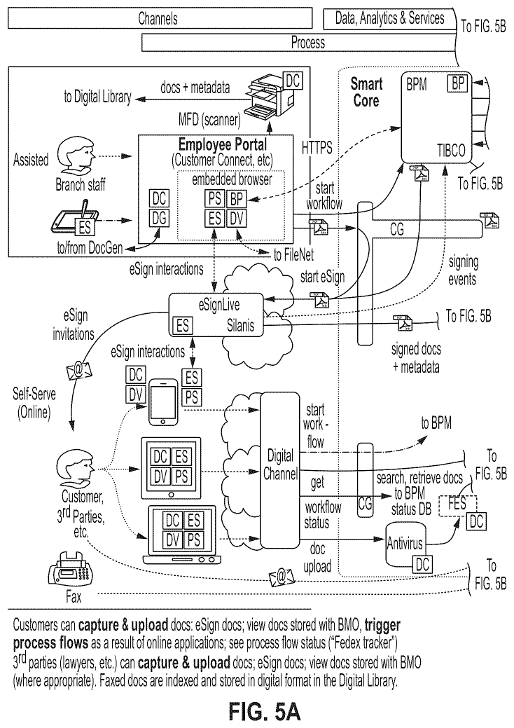

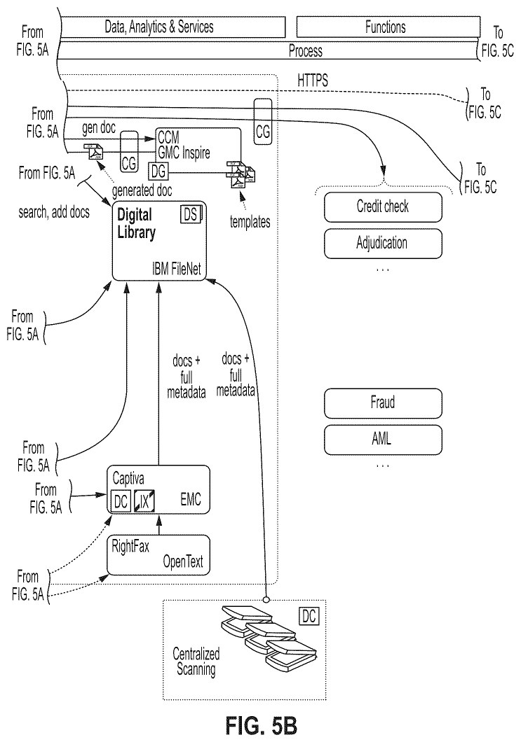

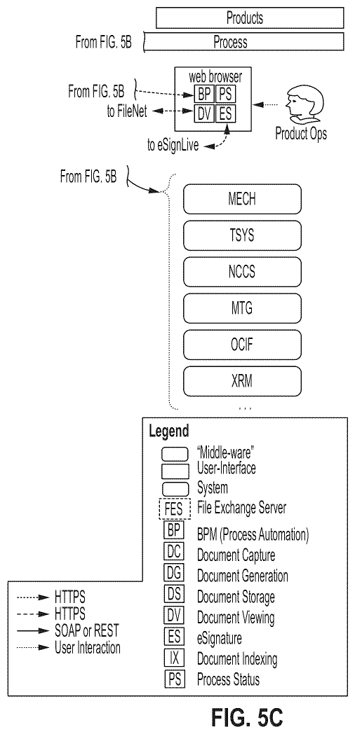

FIGS. 5A-5C depict an example architecture for Digitization and BPM, according to some embodiments. FIGS. 5A-5C are intended to provide an example context for the overall Digitization components. As depicted, a digitization process can flow through a number of various units within stages such as channels; data, analytics, and services; functions; and products. The digitization process can include self-service (online), as well as assisted (e.g., by bank branch employees) processes. Each step is performed by units providing process automation, document capture, document generation, document storage, document viewing, eSignature capabilities, document indexing, and process status, as depicted. Customers can capture and upload documents, eSign documents, view documents stored with the organization, trigger process flows as a result of online applications, and see process flow statuses, for example. Third parties can capture and upload documents, eSign documents, and view documents stored with the organization, for example. Faxed documents are indexed and stored in digital format in the digital library.

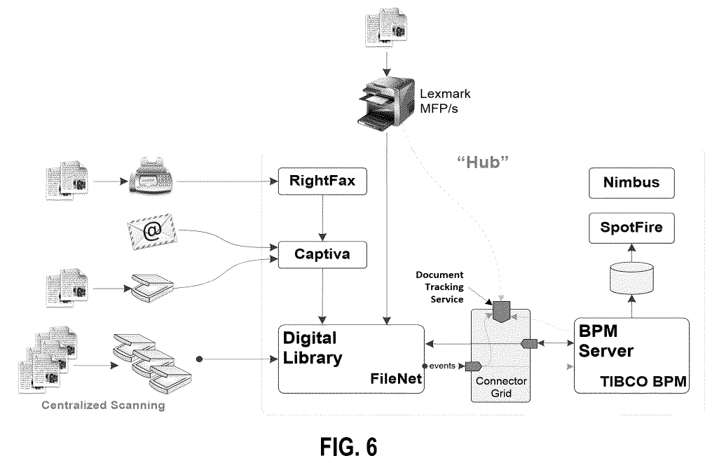

FIG. 6 depicts an example schematic diagram of Document Management implemented by a digitization services platform, according to some embodiments. As depicted, a Hub can receive data, for example, from a centralized scanning unit, which can be provided to a digital library unit. The Hub can include one or more RightFax units, Captiva units, Connector Grids (including document tracking service), BPM servers, databases, a digital dashboard (e.g., SpotFire units), and Nimbus units, each interconnected as depicted.

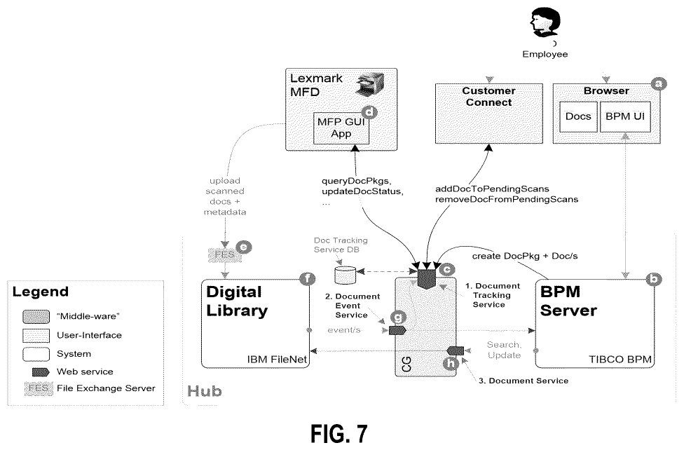

FIG. 7 is a schematic diagram of an example logical architecture for a distributed scanning service of a digitization services platform, according to some embodiments. As depicted, a Hub can include a digital library unit, middle-ware unit, and a BPM server. The middle-ware unit can include a document tracking service, document event service, and document service, as well as provide communication between the digital library unit and BPM server, as depicted. An employee of the organization can engage with a customer connect unit as well as a browser. An MFD unit, for example, can upload scanned documents and metadata to the digital library unit, via File Exchange Server. Data can flow through the depicted units sequentially according to the sequence indicated by the reference letters.

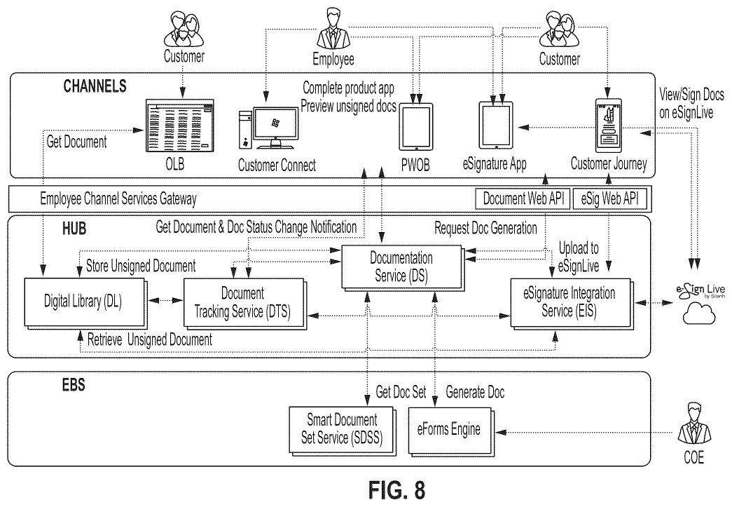

FIG. 8 is a schematic diagram of an example logical architecture for a document generation, e-Signature service of a digitization services platform, according to some embodiments. As depicted, a user can view or sign documents or provided data to a signature unit. The user and/or employee can engage with an eSignature App via a computing unit, a private wealth onboarding unit, customer connect unit, and online banking unit. Each of these units can operate within one or more channel units that interconnect with a Hub, for example, through an employee channel services gateway. The Hub can interconnect with an enterprise banking system unit. The Hub can include a digital library (DL) unit, document tracking service (DTS) unit, document service (DS) unit, and eSignature integration service (EIS) unit. The EBS unit can include a smart document set service (SDSS) unit and an eForms engine. Each of these units can interconnect with other units as depicted. For example, the DL unit can store unsigned documents from the DS unit. The DL unit can retrieve unsigned documents from the EIS unit. The DL unit can receive documents from the OLB unit and vice versa. The DS unit can upload data to the EIS unit. The DS and EIS units can interconnect to provide document generation. The DTS unit can interconnect with the channels unit to receive documents and document status change notifications and vice versa.

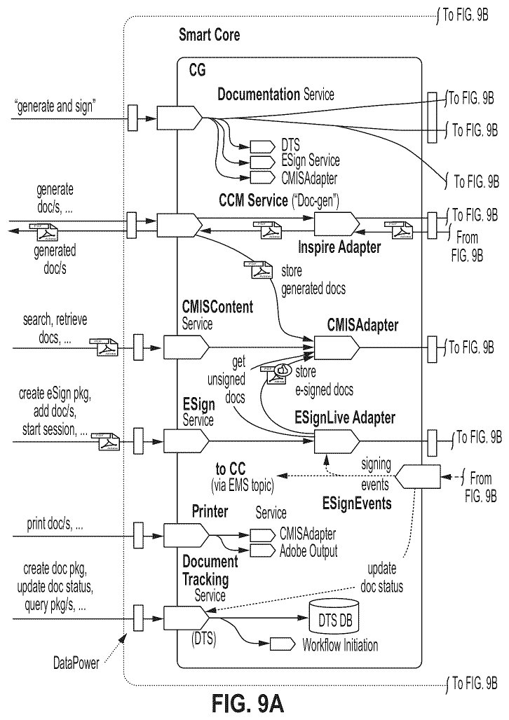

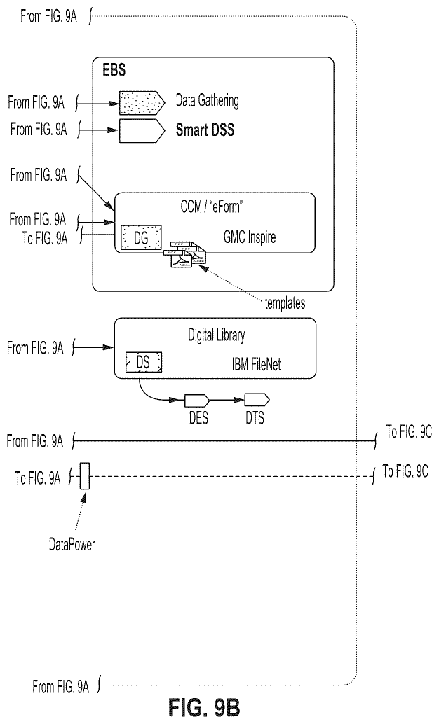

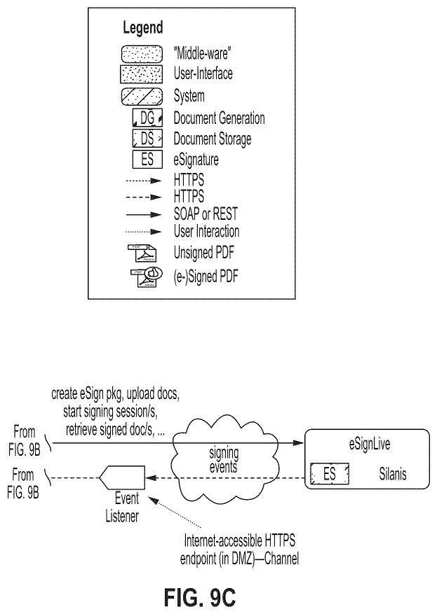

FIGS. 9A-9C illustrate a schematic diagram of an example Document Management and e-Signature key services of a digitization services platform, according to some embodiments. As depicted, the platform can receive a variety of requests. Each request can be managed by a respective service, for example, documentation service, CCM service, CMISContent service, eSign service, printer service, and document tracking service. Each service can be included within a connector grid unit. The CG unit (including various sub-units that can house each service) can interconnect with an enterprise banking system unit, for example, for electronic form services. The CG unit can also interconnect with a digital library. Such interconnection between any of these units can provide document generation, document storage, and/or eSignature services as depicted.

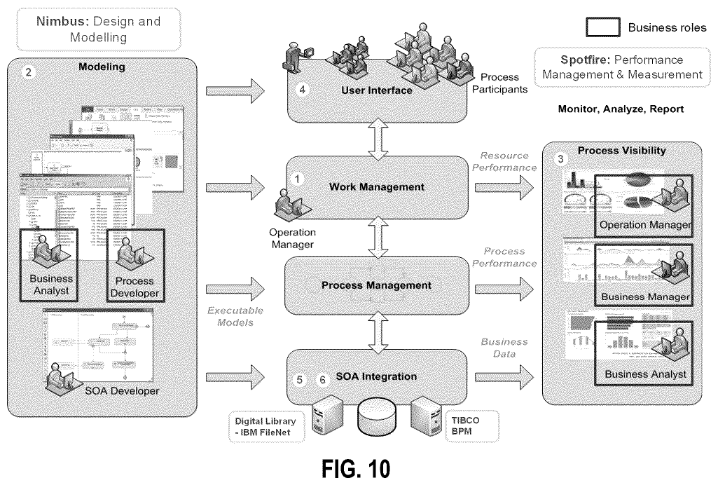

FIG. 10 is a schematic diagram of BPM architecture as implemented by a digitization services platform, according to some embodiments. This can include Process Modelling, Execution, Performance Management, and Robotics. As depicted, the BPM architecture can include a work management unit, process management unit, SOA integration unit, user interface unit, modelling unit (for example, receiving data inputs from business analysts, process developers, and SOA developers), and process visibility unit.

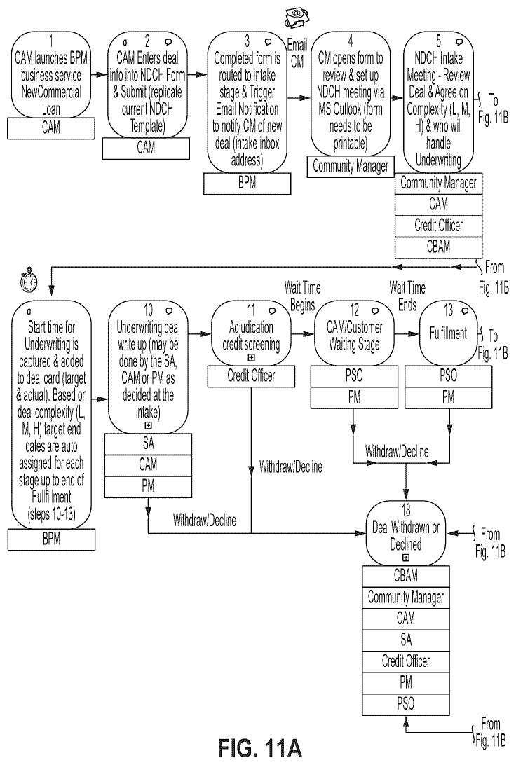

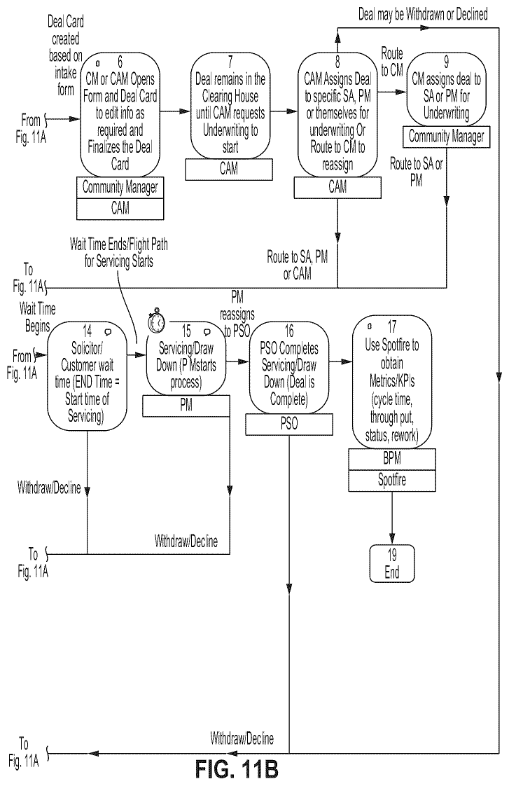

FIGS. 11A and 11B illustrate an example flow chart of an example commercial lending deal cards scenario for process documentation using a digitization services platform, according to some embodiments.

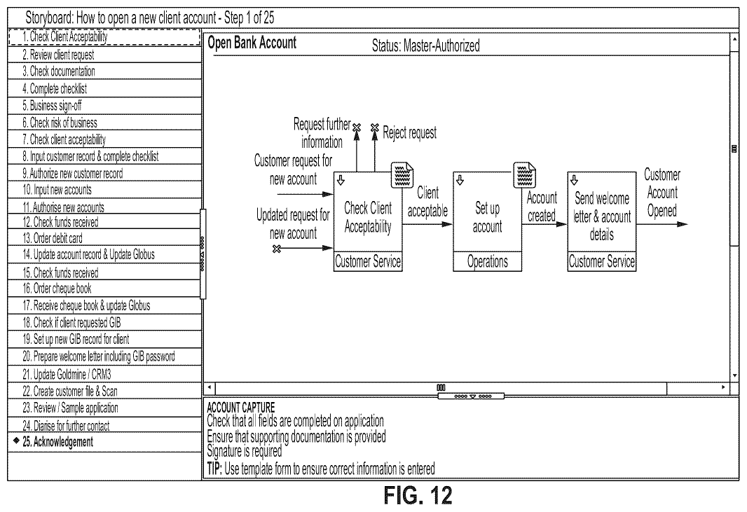

FIG. 12 is a schematic diagram of an example interface for a digitization services platform, according to some embodiments. The interface can provide Storyboards, which can provide a recorded guided route through a process, allowing users to follow a route or process. This can be used for communicating change, training, and best practices. This can provide a hhierarchal process definition with clear accountability at each level, a user-friendly drawing tool to enable collaboration between business experts and business analysts, a repository for process maps and related documentation, along with a browser-based interface accessible by all stakeholders, an ability for process maps to be imported as a baseline flow for process developers, an ability for key performance indicator and service level agreement information to be added to focus process improvement efforts and guide users for performance expectations, and support for governance for process maps.

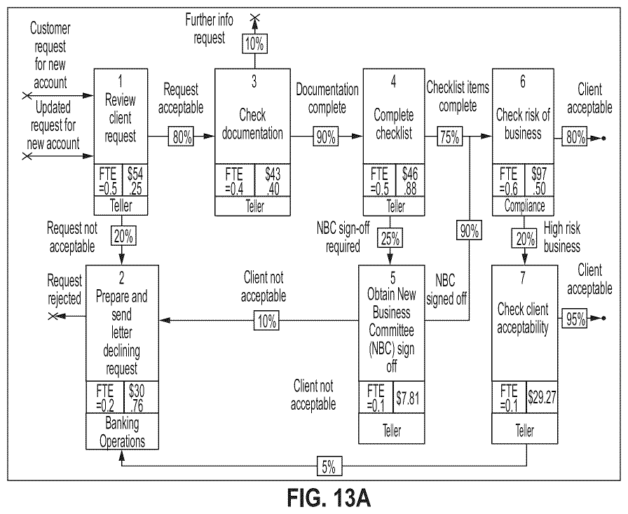

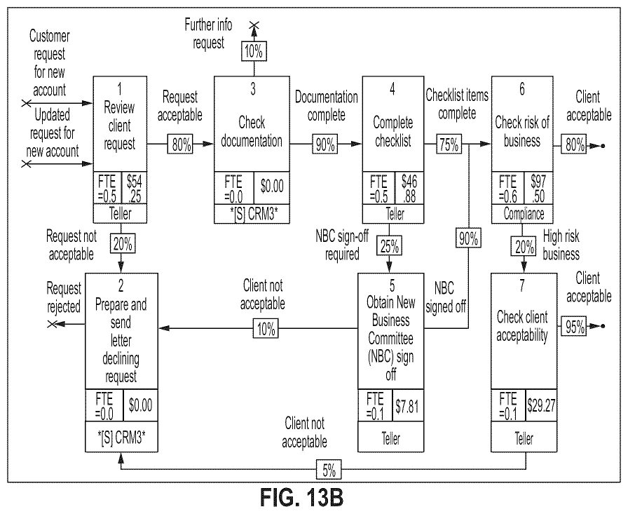

FIGS. 13A and 13B illustrate a schematic diagram of an example process analysis for BPM. Digitization Services Platform can provide an interface to generate the example depicted process schematics before and after scenarios to identify ways to change or improve the process. This can also be used for costed processes to identify savings to be made by “Automating” activities to reduce manual intervention.

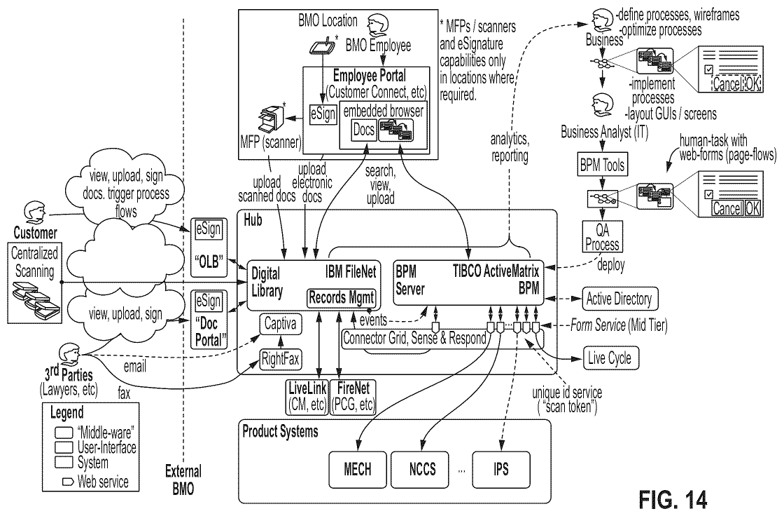

FIG. 14 is a schematic diagram of an example architecture for a BPM unit of a digitization services platform, according to some embodiments. A customer or third parties can provide data to a Hub, as depicted, for example, to view, upload, or sign documents or to trigger process flows. The data can be received by a OLB unit or a Doc Portal unit, which can provide data to a digital library unit included as part of a Hub. The Hub can also include a BPM server and Connector Grid and Sense and Respond units. Web services can provide an interface between the BPM server and a product systems unit. An organization employee can engage with an employee portal, which can provide eSign capabilities and can upload scanned documents and electronic documents and provide search, view, and upload capabilities through interconnection with the digital library unit, as depicted. The various units can further interconnect to provide the various features as depicted.

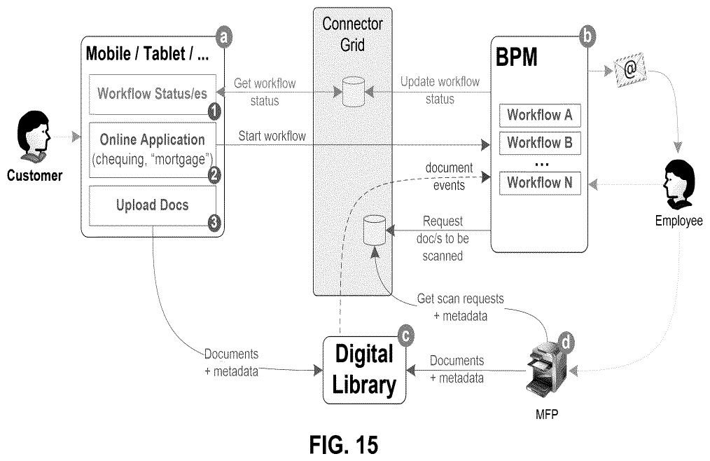

FIG. 15 is a flow diagram of an example process for integration using BPM. As depicted, BPM sends a request to Connector Grid unit for documents to be scanned. BPM unit can also send a request to update workflow statuses at Connector Grid. Connector Grid can request a workflow status at a customer unit. The customer unit can request a workflow to be started at BPM unit. The customer unit can upload documents and metadata to a digital library unit, which can also receive documents and metadata from a MFP unit, which can send scan requests and metadata to the Connector Grid. The Connector Grid can include one or more databases for storage of data.

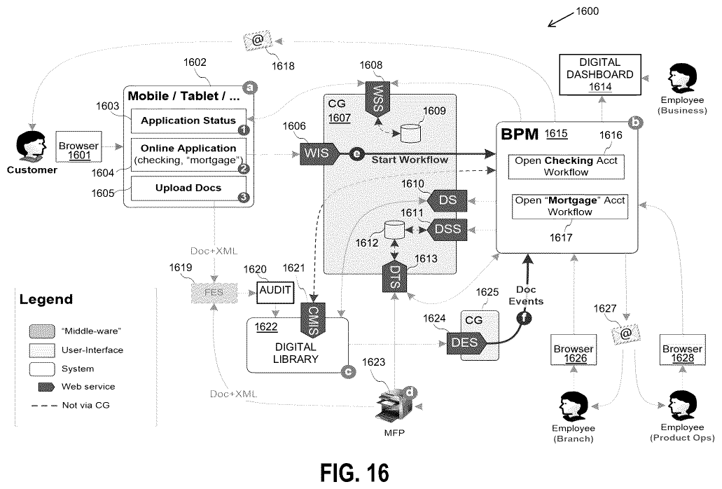

FIG. 16 is a block diagram of an example digitization service platform 1600, according to some embodiments. The digitization service platform 1600 may include a connector grid 1607 and a BPM unit 1615, as discussed herein. A browser 1601 (or an online application) executing on a customer device 1602 may allow a customer to engage with a user interface that provides access to customer-facing functionalities of the digitization service platform 1600. The customer may, using the browser 1601, view an application status 1603 of their applications, commence or edit an online application such as a checking account application or a mortgage account application using an application interface 1604, and/or upload documents for the online application using a document upload interface 1605. The customer device 1602 may be a mobile device, tablet computer, laptop computer, or other computing device.

The customer device 1602 provides data to the connector grid 1607, the BPM unit 1615, and/or a digital library 1622. The data provided by the customer device 1602 may be processed using various web services and in response to various requests. The customer device 1602 may provide data for initiating an online application to the connector grid 1607. The customer device 1602 may provide the data for initiating the online application via a workflow initiation service (WIS) 1606. The WIS 1606 may be part of the connector grid 1607 or may interface with the connector grid 1607. The WIS 1606 may provide the customer device 1602 (and thus the customer) the ability to launch workflows in the BPM unit 1615 using the user interface in the browser 1601. The customer device 1602 may, as part of initiating the online application, or in response to initiating the online application, provide a status of the online application to a workflow status service (WSS) 1608 of the connector grid 1607. The WSS 1608 may store the status of the online application in a workflow status database 1609. The WSS 1608 may provide the status of the online application to the customer device 1602. In this way, the customer device 1602 is able to initialize the status of the online application and view the status of the online application as the status is updated. Thus, a customer can view, using the browser 1601, the status of the online application, including what documents are needed.

The connector grid 1607 transmits the initiation of the online application to the BPM unit 1615. The connector grid 1607 may automatically transmit the initiation of the online application to the BPM unit 1615 using the WIS 1606 in response to the customer device 1602 initiating the online application using the online application portal 1604. In response to the initiation of the online application, the BPM unit 1615 initiates a workflow associated with the online application. The BPM unit 1615 may include an open checking account workflow 1616 and an open mortgage account workflow 1617, among other workflows. Each workflow may indicate required documents, required document types, and required events for the workflow. In an example, the open mortgage account workflow 1617 may indicate a required document type of “proof of income,” including various types of documents which satisfy the required proof of income document type. The BPM unit 1615 may determine which workflow corresponds to the online application initiation received from the WIS 1606.

As part of initiating the workflow, or in response to initiating the workflow, the BPM unit 1615 may send a message 1618 to the customer. In some implementations, the BPM unit 1615 sends the message 1618 to the customer device 1602 via the browser 1601. As part of initiating the workflow, or in response to initiating the workflow, the BPM unit 1615 may send a message 1627 to one or more employees. In an example, the BPM unit 1615 sends the message 1627 to a branch employee who authorizes the workflow and/or to a product operations employee who authorizes the workflow and then sends the message 1618 to the customer to inform the customer that the online application corresponding to the workflow has been initiated. In some implementations, the message 1618 includes a request for the customer to upload one or more documents corresponding to the online application using the customer device 1602. The message 1618 may include the status of the online application. The message 1618 may cause the status of the online application to be displayed on a user interface of the customer device 1602 or the browser 1601. In an example, the message 1618 is an API call. In an example, the message 1618 is an email.

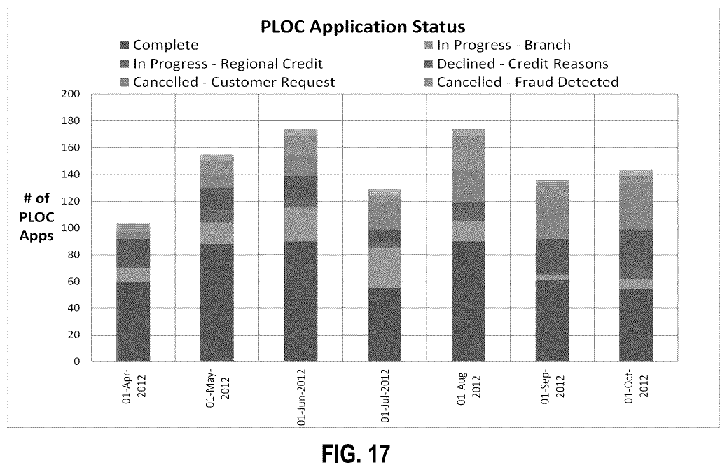

The BPM unit 1615 may transmit an indication of the initiated online application and/or the initiated workflow corresponding to the online application to a digital dashboard 1614. The digital dashboard 1614 may provide visualization data showing a volume of online applications completed, in progress, declined, or cancelled, as shown in FIG. 17. An example of the digital dashboard 1614 is Spotfire.

The BPM unit 1615 may update a status of the online application and/or workflow via the WSS 1608. Throughout the workflow, the BPM unit 1615 may update the status of the online application and/or workflow via the WSS 1608, allowing the customer to track the status of the online application.

The BPM unit 1615 may transmit an indication of the initiated workflow to a document service (DS) 1610 and/or a document set service (DSS) 1611 of the connector grid 1607. The DS 1610 may monitor, track, and organize documents associated with the initiated workflow. The DSS 1611 may track and organize the documents associated with the initiated workflow, comparing them to document requirements of the workflow such as a number or type of documents required by the workflow. In some implementations, the DS 1610 and the DSS 1611 are a single service of the connector grid 1607.

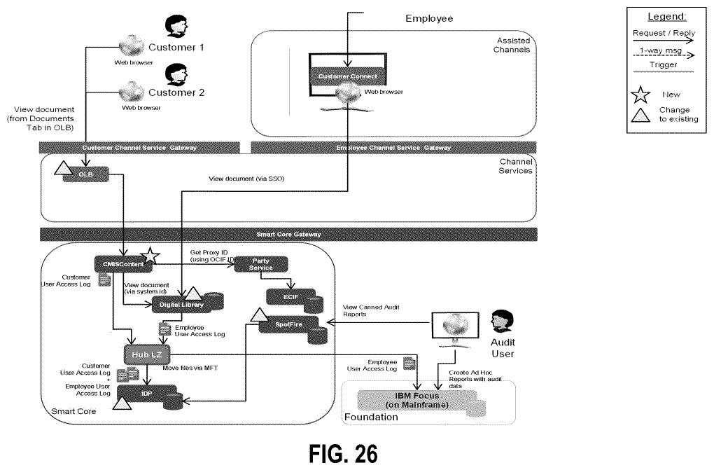

The customer device 1602 may upload documents associated with the online application and/or the corresponding workflow using the document upload interface 1605. In some implementations, the customer device 1602 may upload the documents to a file exchange server 1619. In some implementations, the customer device 1602 may upload the documents to an audit unit 1620. The audit unit 1620 may be an audit logging and reporting service of the digitization service platform 1600, as discussed in conjunction with FIG. 26. In some implementations, the customer device 1602 may upload the documents directly to a digital library 1622.

Documents may be uploaded to the digital library 1622 (via the file exchange server 1619 and/or the audit unit 1620 or directly) from a multi-function printer (MFP) 1623. The MFP 1623 may include a scanner for scanning physical documents. The MFP 1623 may be integrated with the digitization service platform 1600 to digitize documents and automatically upload the documents for storage and management. In an example, the MFP 1623 may, as documents are scanned, automatically upload the scanned documents to the digital library 1622. In an example, the MFP 1623 requests a document to be scanned corresponding to a workflow and, upon scanning document, automatically uploads the document along with information corresponding to the workflow. In some implementations, workflows can request documents to be scanned using the MFP 1623. In an example, the BPM 1615 sends a request to the customer (e.g., via the message 1618) and/or a request to an employee (e.g., via the message 1627) to scan and/or upload a document using the MFP 1623. In an example, the BPM 1615 sends a request for a signed document to be scanned using the MFP 1623.

The digital library 1622 may determine one or more document events based on the uploaded and/or scanned and uploaded documents. The digital library 1622 may perform OCR and other processes to identify information in the documents to extract the one or more characteristics of the documents, one or more characteristics of the content of the documents, and/or one or more events indicated by the one or more characteristics of the documents or one or more characteristics of the content of the documents. The digital library 1622 may include a set of modules configured to perform various tasks. The digital library 1622 may include an OCR module, a content management interoperability service (CMIS) 1621, a document AI model, and/or a document AI application. The connector grid 1607 may provide interfaces to the digital library 1622 and/or each of the modules of the digital library 1622. The document AI model may include an artificial intelligence (e.g., machine-learning) model to recognize and extract text attributes or characteristics from document images and/or document files. The document AI application may include a user interface to provide human-in-the-loop (HITL) functionality for the AI model, such as handling Al model exceptions. In an example the document AI application provides HITL input for a human to handle text that the document AI model does not recognize.

The digital library 1622 may transmit the one or more characteristics to a document event service (DES) 1624. The DES 1624 may be a service of the connector grid 1607 or a service of a separate connector grid instance 1625. The DES 1624 may determine one or more events based on the one or more characteristics. In an example, the DES 1624 may determine a proof of income completion event based on the one or more characteristics indicating that the documents satisfy proof of income requirements of the workflow and/or online application. In an example, the DES 1624 determines a signing event based on the one or more characteristics indicating that a document has been signed. In this example, the DES 1624 may cause the signed document to be uploaded to a document database 1612 as a signed document and/or to replace an unsigned document in the document database 1612. The DES 1624 may identify and/or determine an online application and/or workflow corresponding to the document events. The DES 1624 may transmit the document events with identifying information to the BPM unit 1615.

The BPM unit 1615 may, in response to receiving the document events, update a status of the online application using the WSS 1608, transmit the document events to the DS 1610, transmit the document events to the DSS 1611, and/or transmit the document events to a document tracking service (DTS) 1613. The DTS may track documents which are uploaded and/or scanned and uploaded by the MFP 1623. The DTS 1613 may receive and update a status of documents based on uploaded documents and/or document events. In an example, the DTS 1613 may update a document status as “signed” based on the document being signed, as reflected in a document event. The DSS 1611 and/or the DTS 1613 may store the documents and/or the status of the documents in the document database 1612, also referred to as a document library. The DSS 1611 and/or the DTS 1613 may access the document database 1612 to track and monitor the documents and the status of the documents. The DTS 1613 may update the BPM 1615 as to the status of the documents. The BPM 1615 may update the status of the online application and/or corresponding workflow via the WSS 1608 based on the status of the documents.

In some implementations, the DTS 1613 tags documents with tags, identifiers, or other data attributes for tracking, associating, and identifying the documents. In an example, the DTS 1613 may tag documents with a corresponding required document type. In an example, the DTS 1613 may tag documents with an origin of the documents (e.g., scanned by the MFP 1623 in response to a request associated with a specific online application, uploaded by the customer device 1602 for a specific online application). In an example, the DTS 1613 may tag documents with an identifier of a corresponding online application. In this way, the DTS 1613 may tag documents such that the documents can be identified and searched according to their context, (e.g., searched and retrieved according to the corresponding online application).

In some implementations, the DTS 1613 generates document packages corresponding to the required documents for an online application, as indicated by the corresponding workflow. The DTS 1613 may generate a document package identifier and associate documents in the document database 1612 with the document package identifier to update the document package. The DTS 1613 may tag the documents of a document package with the document package identifier. The DTS 1613 may track events associated with the online application to update the document package. In some implementations, the DTS 1613 updates the BPM unit 1615 as to a status of the document package which the BPM 1615 uses to update the status of the online application and/or the workflow.

In some implementations, the CMIS 1621 of the digital library 1622 ensures that documents received from different sources are correctly tracked, monitored, and analyzed. The CMIS 1621 may transmit messages between the BPM unit 1615 and the digital library 1622 to search and retrieve documents corresponding to the online application and/or the corresponding workflow and to ensure that documents received from different sources do not contain duplicates but are correctly identified. In an example, the CMIS 1621 facilitates communication between the BPM unit 1615 and the digital library 1622 to ensure that a signed document is correctly identified as a signed version of a document and not a new document.

The BPM 1615 may allow the customer to view documents and a status of the online application and corresponding documents using the browser 1601 as the application is processed and completed. The BPM 1615 may allow employees to view documents and a status of the online application using the browser 1626 and/or the browser 1628 as the application is processed and completed. The BPM 1615 may allow the customer and/or employees to upload and/or scan and upload documents using the browser 1601, the browser 1626, the browser 1628, and/or the MFP 1623. In this way, the BPM 1615 provides visibility into determined events, documents, status of documents, and status of the online application.

Examples of Process Performance Management using a digital dashboard, such as the digital dashboard 1614, will now be described.

FIG. 17 is a chart depicting an example display for a volume monitoring process, according to some embodiments. The volume monitoring process can include retrieving an application status at each step in the workflow—e.g., Branch & Operations managers to monitor volume. This can be configured to be viewed intraday (i.e. hourly) or daily, weekly, monthly intervals as required.

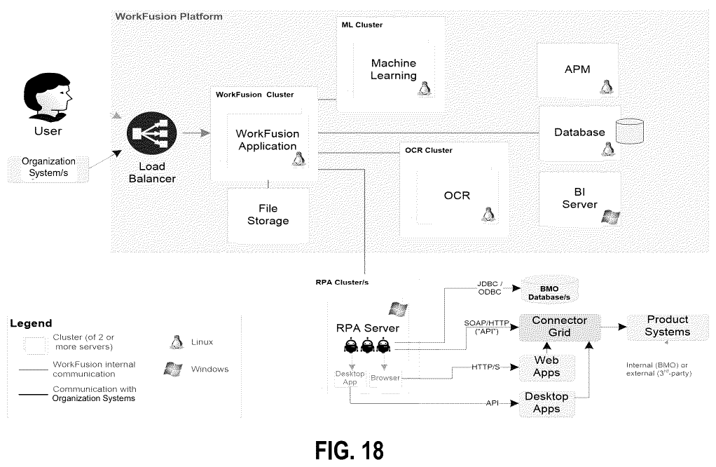

FIG. 18 is a schematic diagram of an example logical architecture for Robotic Process Automation, according to some embodiments. As depicted, the architecture includes a WorkFusion Platform, which a user device or organizational system can provide input data to or otherwise engage with. The WorkFusion Platform includes a load balancer, WorkFusion Cluster unit (including one or more WorkFusion Applications), File Storage unit, ML Cluster unit (including one or more machine learning units), OCR Cluster unit (including one or more OCR units), databases, business intelligence servers, and application portfolio management units. The WorkFusion Cluster unit can interconnect with one or more robotic process automation Clusters, including one or more RPA Servers, each of which can provide data (according to various protocols such as JDBC/ODBC; SOAP/HTTP; HTTP/S, etc.) to one or more of each of organization databases, Connector Grid units, Web Applications, and Desktop Applications. The connector Grid unit can provide data to the organization or a third party's Product Systems unit.

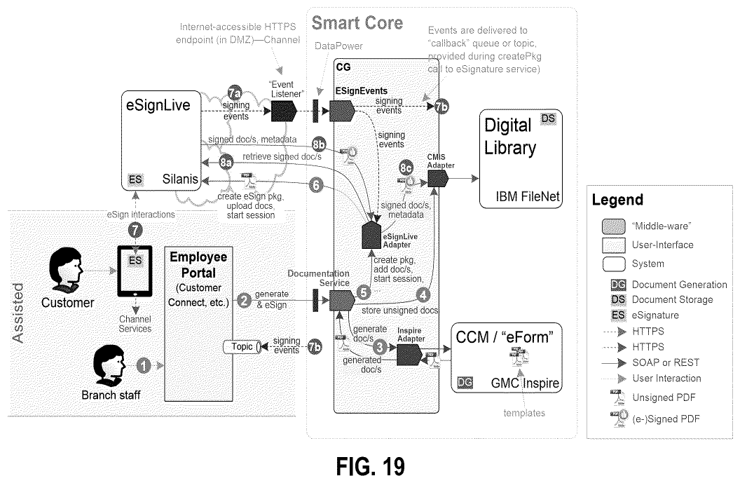

FIG. 19 is a schematic diagram of an example architecture implementing an eSignature (Assisted Channel) use case for a digitization services platform, according to some embodiments. The architecture can include an Employee Portal unit, signature unit, and IDP. The IDP can include a CG unit, digital library unit (e.g., Filenet unit), and CCM/eForm unit. Each of these units can interconnect as depicted to provide the various depicted functionalities using the various depicted protocols and sequences.

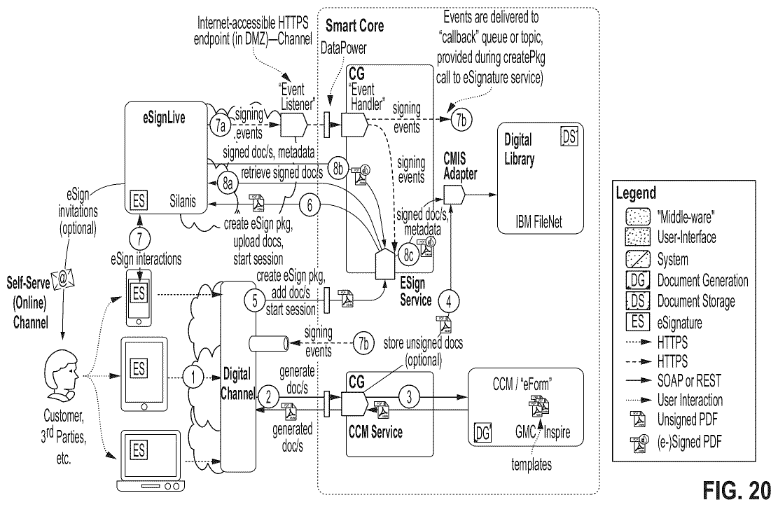

FIG. 20 is a schematic diagram of an example architecture implementing an eSignature (Online Channels) use case for a digitization services platform, according to some embodiments. Specifically, depicted is a Digital Channel using the CCM Service and eSignature Service as two distinct web-services (and two invocations). The Documentation Service allows channel applications, BPM, etc. to generate documents needed for a particular product as well as initiate e-Signature for relevant documents in a single web-service call. The “one-stop shop” Documentation Service, however, might not be reusable (or desired) in particular use-cases, in which case the CCM and ESign Services can be utilized as “standalone” services, as depicted here. The architecture can include an signature unit, Digital Channel unit, and SmartCore, which can include one or more CG units, a digital library (e.g., Filenet), and a CCM/eForm unit.

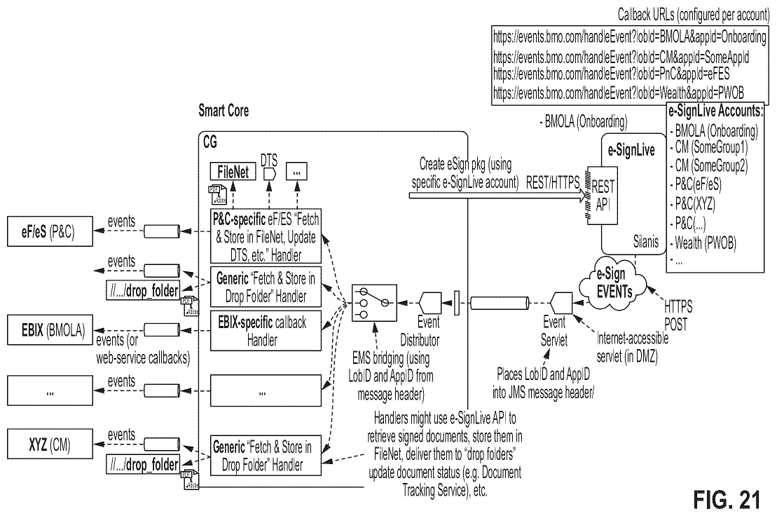

FIG. 21 is a schematic diagram of an example architecture implementing Event Handling for an e-Signature functionality. As depicted, the platform can include a CG unit, with the various depicted handlers. Each handler can provide event data to one or more external units, as depicted. The CG unit can also create an eSign package using a specific account and provide same to an external signature unit using a REST/HTTPS protocol. The signature unit can provide eSign Events to an event servlet to provide same to an event distributor unit included as part of the CG unit.

Example embodiments of Hub E-Forms and ESign Services as part of a Hub will now be described in further detail.

Enterprise Core Standards can include a Document Management Product Standard (STD-0081-01) and a Hub SOAP Message Format (STD-0105-01).

Embodiments described can provide e-Signature Services that support enterprise-wide reuse.

In some embodiments, there may be a set of electronic forms, a Customer Communication Management (CCM), “eForms” platform and e-Signature platform along with channel interaction.

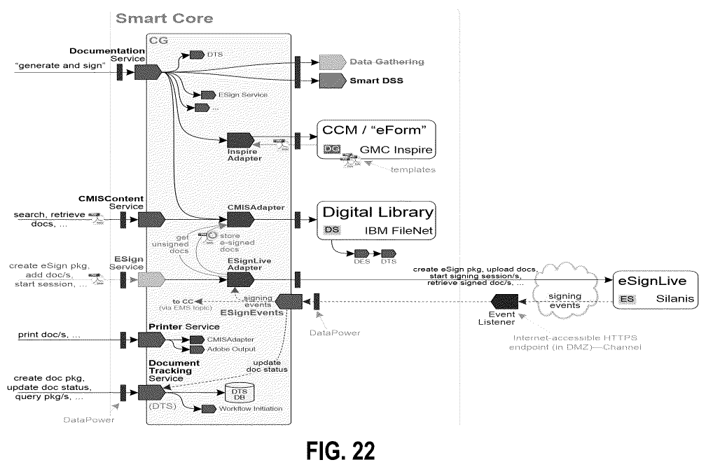

FIG. 22 is a schematic diagram of an example state of an e-Signature architecture, according to some embodiments. As depicted, the platform can receive data via a variety of respective services and can include a CG unit and various other units.

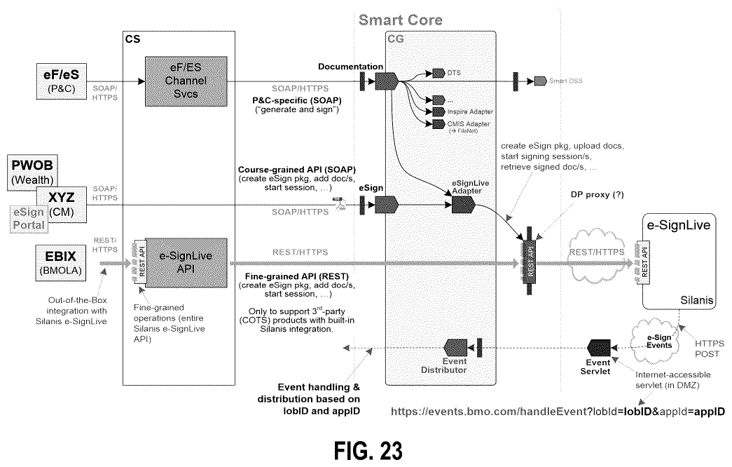

FIG. 23 is a schematic diagram of an example state of an e-Signature architecture, according to some embodiments. As depicted, the platform can receive data via a variety of respective services from a corporate services unit.

Other service, such as the Document Event Service (DES), Employee Notification Service, play a part in the overall eForms and e-Signature implementation, but have been omitted from this diagram. In addition, existing services supporting Branch Scanning, though used by eForms and e-Signature services, are not displayed. The EICEmployee service is also not depicted.

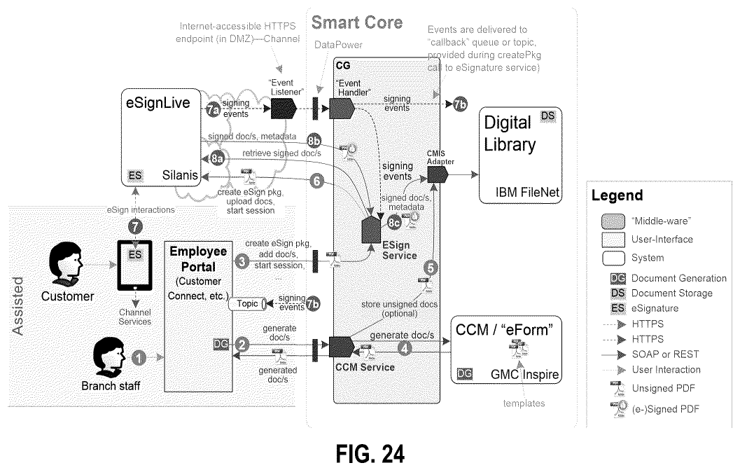

FIG. 24 depicts an example architecture for an eSignature Service (Assisted Channel, ESign and CCM Services). Specifically, there is depicted an Employee Portal (e.g. Customer Connect) using the CCM Service and eSignature Service as two distinct web-services (and two invocations).

The context of an example Documentation Service according to some embodiments of a digitization services platform is to provide a “one-stop shop” service to channels, allowing documents to be generated, stored in the digital library (Filenet), and submitted for electronic signature.

The scope includes a GenerateAndESign unit, which generates documents associated with a specified product, stores the unsigned documents in the digital library (e.g., Filenet), and submits documents to be e-signed for electronic signing; a GenerateAndPrint unit, which generates documents associated with a specified product, stores the unsigned documents in the digital library, and sends documents to be “paper” signed to a network-attached printer for printing; a ReassignPackages unit, which reassigns DocumentTrackingService (DTS) document packages from one employee to another; and a RemovePackages unit, which removes the specified DocumentTrackingService (DTS) document packages, along with any e-Sign packages that may exist.

The context of an example Customer Communication Management (CCM) (“Document Generation”) Service according to some embodiments of a digitization services platform is to provide the means for applications (such as Customer Connect, the Digital Channel, BPM, etc.) to generate documents (typically output as PDFs), returning generated documents to the caller and/or storing them in the digital library and/or placing them into a user-specified output folder.

The scope includes a Generate Documents unit, which can generate one or more documents, either returning them to the caller (as attachments), or storing them in the digital library or a caller-specified output folder.

The context of an example Document Tracking Service according to some embodiments of a digitization services platform is to provide an ability to track acquisition, scanning and/or electronic signing of documents, as well as state management and query capabilities.

The platform includes an AddPackagesToPendingPackages unit, which changes the status of document packages to “pending”; a QueryMyPendingPackages unit, which allows a caller to query pending document packages; and a RemovePackagesFromPendingPackages unit, which removes the specified packages from the pending state.

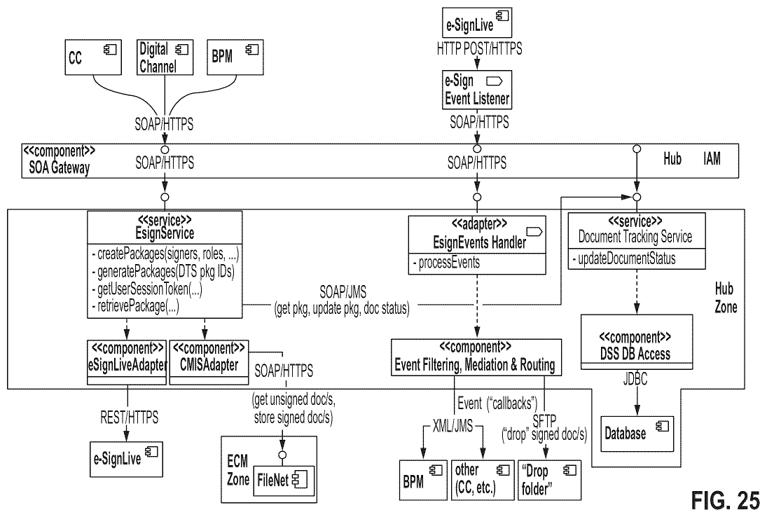

FIG. 25 is a schematic diagram of an example architecture for Component Interaction between ESign Service, Handlers, and Document Tracking services. The diagram provides a component-interaction view of the ESign and Document Tracking services, and ESignEvents handler.

In some embodiments, there is provided a Documentation Service, which can interconnect with various components.

Embodiments described herein can provide operational logging and auditing services.

FIG. 25 is a schematic diagram depicting some embodiments where Hub services involved in eForms are e-Sign processing can log component health and transaction processing to support operational monitoring.

In addition, as depicted, access to documents stored in the digital library (e.g., Filenet) (whether by customers via OLB, or by employees via the UI and/or Customer Connect) is to be recorded for audit purposes. This may be that the CMISContent adapter produce an audit log of customer access to documents, and that the digital library produce and audit log of employee document access.

FIG. 26 is a schematic diagram of an example architecture for an Audit Logging and Reporting service of a digitization services platform, according to some embodiments. In some embodiments, content management service will log the certain data elements for audit reporting relating to customer document accesses; content management service can log the Proxy ID of the customer user accessing documents from the digital library (e.g., Filenet); the digital library can log the user IDs of employee user access; the digital library can log the user accesses for customers; Customer and Employee user access logs are shipped to IDP; and reports can be created to allow audit users to view DL document access activities by customers or employees.

The architecture can include logging accesses to documents in a digital library (e.g., Filenet unit), as well as enabling an audit team to review reports.

This table summarizes some significant architectural and management decisions that may be involved in the design of the architecture.

In some embodiments, adds, changes and deletes to the data can be monitored.

Functions and applications can be changed in any one of the following ways: connection to the HUB via an adaptor; consumption of CIF information from MDM/HUB; consumption Analytic information from HUB and/or Virtual EDW; migration of orchestration to the HUB; migration of business logic to the HUB; migration of presentation logic to the HUB; and movement to strategic standards from non-strategic standards (includes platforms).

According to some embodiments, the following table summarizes system-to-system interfaces between components.

| Source | Destination | Protocol | Sync/Async | Notes |
|---|---|---|---|---|
| Browser | ESign Service | HTTPS | Synchronous | Browser-based UI |
| BPM | ESign Service | SOAP/ | Synchronous | Workflows running on BPM can |
| | | HTTPS | | create eSign packages, add |
| | | | | documents to a package (by |
| | | | | specifying FileNet URLs), and |
| | | | | invite customers to sign. |
| Customer | ESign Service | SOAP/ | Synchronous | The Digital Channel and |
| Connect, | | HTTPS | | Customer Connect can create |
| Digital Channel | | | | eSign packages, add documents |
| | | | | to a package (either existing |
| | | | | documents stored in database, |
| | | | | or newly generated documents |
| | | | | directly uploaded to the |
| | | | | eSignature Service), invite |
| | | | | customers to sign, and start an |
| | | | | e-sign session. |
| ESign Service | ESign Service | REST/ | Synchronous | The ESign Service uses a |
| | | HTTPS | | signature API |
| ESign Service | Digital Library | SOAP/ | Synchronous | The ESign Service uses the |
| | | HTTPS | | CMISAdapter retrieve |
| | | | | documents (before uploading |
| | | | | them for signing), and to store e- |
| | | | | signed document/s. |
| signature | e-Sign Event | JSON/ | Synchronous | Signing events are delivered to |
| process | Listener | HTTPS | | the eSignature Event Listener |
| | | | | using HTTP POSTs sent to an |
| | | | | HTTPS endpoint (the eSignature |
| | | | | Event “Listener”). The URL can |
| | | | | include a shared key. Each |
| | | | | HTTP POST carries the shared |
| | | | | key, allowing the Event Listener |
| | | | | to validate the origin of the |
| | | | | events. |
| eSignature | ESignEvents | JSON/ | Synchronous | Events received by the |
| Event Listener | Handler | HTTPS | | eSignature Event Listener are |
| | | | | passed to the Connector Grid's |
| | | | | eSignature Event Handler via |
| | | | | HTTP POST, which distributes |
| | | | | the events to interested parties |
| | | | | as needed. |
| ESignEvents | ESign Service | REST/ | Synchronous | When a ‘package complete’ |
| Handler | | HTTPS | | event is received by the |
| | | | | ESignEvents Handler, the |
| | | | | handler notifies the ESign |
| | | | | Service, which retrieves the |
| | | | | signed document/s and stores |
| | | | | them. |
| ESign Service | Digital Library | SOAP/ | Asynchronous | After downloading signed |
| | | HTTPS | | document/s, the eSignature |
| | | | | Event Handler stores the |
| | | | | documents. |
| ESign Service | “Drop folder” | SFTP | Asynchronous | If signed documents are not |
| | | | | stored, then ESign Service can |
| | | | | deliver the signed documents to |
| | | | | a “drop folder” (specified at the |
| | | | | time the e-sign package was |
| | | | | created). |
| ESignEvents | “Callback” | XML/ | Asynchronous | Signing events received by the |
| Handler | queue/topic | JMS | | ESignEvents Handler posted to |
| | | | | the “callback” queue or topic |
| | | | | provided at the time that the e- |
| | | | | sign package was created. |
| ESignEvents | Document | SOAP/ | Synchronous | When signing events containing |
| Handler | Tracking | HTTPS | | a DTS packageID and |
| | Service (DTS) | | | documentID are received, the |
| | | | | Event Handler invokes |
| | | | | updateDocumentStatus(SIGNED) |
| | | | | on the Document Tracking |
| | | | | Service. |
| Customer | EICEmployee | SOAP/ | Synchronous | Get employee information (i.e. |
| Connect | Service | HTTPS | | job role, etc.). |

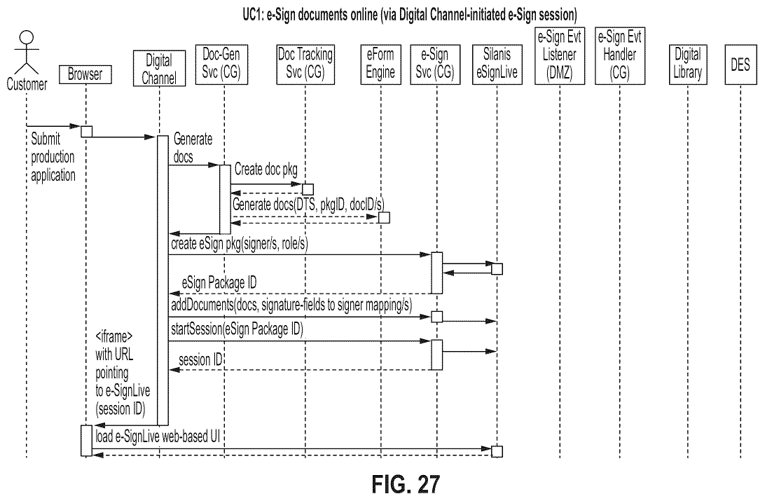

FIG. 27 is a schematic diagram of an example process for e-Signing documents online (via a Digital channel-initiated e-Sign session), according to some embodiments. As depicted, data can flow through a browser unit, digital channel unit, Doc-Gen service (CG) unit, doc tracking service (CG) unit, eForm engine, eSign service (CG), eSign event listener (DMZ), eSign event handler (CG), digital library unit, and DES unit.

In some embodiments, the following services are authenticated using SPNEGO (via DataPower): CMISContent, documentation, DocumentTrackingService, eSign, and printer.

In these embodiments, these services are exposed to channel applications as SOAP/HTTPS endpoints.

The following table describes features of an example digitization services platform, according to some embodiments.

| Quality | | |
|---|---|---|
| Attribute | Definition | Specifications and solution |
| Availability | The ability of the system | Continuous: The system can be |
| | that represents a measure | continuously available to users, Monday |
| | of its readiness for usage | through Sunday, 365 days a year, |
| | (e.g., Hours of operations) | excluding scheduled maintenance. |
| | | Scheduled maintenance will be defined in |
| | | the Operational Level Agreement. |
| | | Application and infrastructure |
| | | components are designed to allow for |
| | | ‘continuous’ availability. Disaster recovery |
| | | component should be available with |
| | | recovery time object of 4 hours |
| | | DR components are integrated into the |
| | | application and infrastructure design |
| Reliability | The ability of the system to | Minor outage - Up to 15 minutes |
| | keep operating over time. | Major outage - up to 1 hour |
| | Reliability is usually | Critical outage - >1 hour |
| | measured by mean time to | ‘Continuous’ availability is designed into |
| | failure (% downtime). | the application and infrastructure design |
| Performance | The responsiveness of the | Online Response time |
| | system - that is, the time | Capacity planning is based on the |
| | that may be used to | performance criteria. Performance testing |
| | respond to stimuli (events) | is part of the development process. |
| | or the number of events | |
| | processed in some interval | |
| | of time. Often expressed | |
| | by the number of | |
| | transactions per unit time, | |
| | or by the amount of time | |
| | that it takes to complete a | |
| | transaction with the system | |
| | (e.g., Transaction latency | |
| | and volume, Peek | |
| | performance | |
| | characteristics). | |
| Scalability | The ability to maintain or | Time frame: 5 years. Organic growth |
| | improve performance while | expectation - 10% increase in customers |
| | system demand increases | and their transaction |
| | (e.g., transaction volume | The application and infrastructure design |
| | growth). | allow scaling vertically and horizontally |
| | | for the organic & planned growth |
| Security | A measure of the system's | SSL (HTTPS) between browser. |
| | ability to resist | SSL mutual-auth between BPM and CG, |
| | unauthorized attempts at | via DataPower. |
| | usage and denial of | FileNet uses standard AD-based logins |
| | service, while still providing | and SSL. |
| | its services to legitimate | |
| | users. Security is | |
| | categorized in terms of the | |
| | types of threats that might | |
| | be made to the system. | |
| Maintainability | The aptitude of a system to | All changes will be handled through the |
| | undergo repair and | Production Change Process. |
| | evolution. | Allow Operations to move an application |
| | (1) The ease with which a | from one server to another, independent |
| | software system or | of any other application, and without |
| | component can be | application code changes. |
| | modified to correct faults, | Design to enable rolling upgrades/ |
| | improve performance or | staged implementation. |
| | other attributes, or adapt to | |
| | a changed environment. | |
| | (2) The ease with which a | |
| | hardware system or | |
| | component can be retained | |
| | in, or restored to, a state in | |
| | which it can perform | |
| | functions. | |
| Supportability | The ease with which a | Application and infrastructure |
| | software system can be | components supports EI standard |
| | operationally maintained. | monitoring tools. Will deploy EI standard |
| | | monitoring tools; TIVOLI, BMC, |
| | | Intrascope, etc.). |
| Reusability | The degree to which a | Solution uses the HUB shared services |
| | software module or other | (BPM and FileNet). |
| | work product can be used | |
| | in more than one | |
| | computing program or | |
| | software system. This is | |
| | typically in the form of | |
| | reusing software that is an | |
| | encapsulated unit of | |
| | functionality. | |
| Extensibility | Description on how | The HUB services are architected to |
| | architecture | support enterprise extensibility |
| | accommodates future | |
| | changes. | |

The following table describes mapping between application components and various components of a digitization services platform, according to some embodiments.

| Application/Solution | |
|---|---|
| Components/Services | Platform |
| Gateway | Data Power |
| Documentation Service | CG |
| Document Tracking Service | CG |
| Document Event Service | CG |
| Smart DSS | EBS - Java on WAS (Liberty Base |
| Employee Notification | CG (EMS Topic) |
| Documents Operational | IDP and Spotfire |
| Reports | |
| Printer Service | CG |
| CMISContent | CG |
| EICEmployee | CG |
| BPM | Hub BPM |

In some embodiments of digitization services platform, the following process digitization core areas can have a variety of technology standards and example states and alignment: scanning, document management, workflow, e-Signature, search, specialized workflows.

For example, various technology standards are provided for process digitization services, according to some embodiments.

| Category | Description |
|---|---|
| Process Documentation | Document and analyze business processes; make process |
| | documentation available to employees. |
| Fax | Send and receive electronic faxes |
| Capture & Scanning | Convert paper to electronic format (Scan, Fax), including |
| | extraction of metadata and other info from scanned |
| | documents or images (such as TIFF files from received |
| | faxes) using OCR, bar-code reading, etc. and ingest |
| | captured documents into Content Management system. |
| Archive/Document Management | Provide storage, search and retrieval for electronic |
| | documents-typically those associated with customer- |
| | related activities (e.g. loan applications, proof of |
| | employment, income verification)-as well as manage |
| | document lifecycle (e.g. records management) |
| Workflow | Automate business processes and provide insight into |
| | process performance, cycle-times, etc. allowing for |
| | continual process improvement/refinement. |
| e-Signature | Allow customers and employees to electronically affix a |
| | signature or its equivalent to an electronic document, both |
| | online (“unmediated signing”¹) and person (“mediated”¹, |
| | in-branch, for example). |
| Search | Search for (electronic) documents based on user-entered |
| | search criteria. Currently search is limited to documents |
| | stored in FileNet, but future capabilities July extend search |
| | across Sharepoint, LiveLink, etc. |
| Collaboration | Enable internal (employee-to-employee) and external |
| | (employee-to-customer) collaboration and document |
| | sharing. |
| Specialized Workflows | |

There may be provided mediated or unmediated e-signing.

In some embodiments, various specialized workflows are provided or technology standards used for process digitization services.

“Specialized workflows” refers to use-cases where workflow functionality is used, and such “workflow” functionality might already exist within an off-the-shelf product being considered, or a strong case can be made to use an alternative to the organization's workflow standard (e.g., BPM).

In general, for new “specialized workflows” BPM should be considered for use. Where workflows need to span both front-office (branch) and product operations, BPM provides strong support.

Each new “specialized workflow” should be considered on a case-by-case basis using the standard Hub Intake process.

Migration of existing “specialized workflows” to BPM should be considered as/when business process improvement is desired.

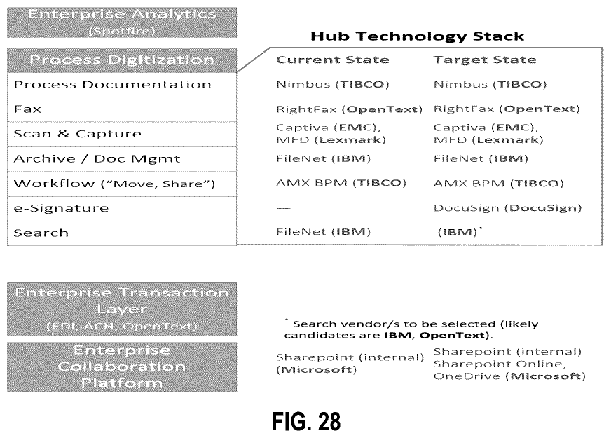

FIG. 28 is a schematic diagram of example capabilities and vendors for process digitization services, according to some embodiments.

The following table summarizes example capabilities for process digitization services, according to some embodiments.

Capability

Process Documentation
Fax
Scan & Capture
Archive/Document Management
Record Management
(associated with Archive/Doc Mgmt)
“Workflow”
eSignature
Search
Collaboration

The following table describes various standards used for the below-listed use cases, according to some embodiments.

Use-case

P&C Product Operations “Workflow”
Customer Onboarding
P&C Mortgage Workflow
US AML High-Risk Unit (HRU) Workflow
P&C Commercial Lending Workflow
(“specialized workflow”)

The diagram shows the established integration between key components of the Hub's Digitization Foundation, for example RightFax, Captiva, Digital Library, and BPM. For example, for RightFax, faxes received by RightFax are routed for image quality improvement and indexing. For faxes, scanned documents that are processed (image quality checks, enhancement, indexing) are, among other paths, routed into the Digital Library for storage and subsequent retrieval. For the Digital Library, the Digital Library has been integrated (via Connector Grid) with: branch-scanning solutions (allowing scanned documents to be directly uploaded and stored); BPM, sending notifications to workflows when documents are stored/updated, allowing workflows to automatically move on to the next step in the workflow (typically a “Review documents step”); and end-user applications, allowing employees to search for documents stored in the Digital Library, update document metadata, etc. directly from familiar applications (such as Customer Connect, BPM workspace, etc.).

For BPM, for Branch Scanning services, BPM is integrated with the branch scanning solution, allowing workflows to request documents to be scanned, and employees to use in-branch MFDs to scan documents directly into the workflow. BPM is tightly integrated with a digital dashboard (e.g., Spotfire), allowing process cycle times, etc. to be visualized, and enabling continual process improvement.

The diagram shows an example state of the organization's Process Digitization technology stack. Key points are the addition of e-Signature services (both in-branch and online); ability for customers to upload documents from online channels (shown as “OLB” in the diagram); and ability to launch workflows in BPM from channels (e.g. mobile, tablet).

The diagram shows a view of the target state of the organization's Process Digitization technology stack. Key points are an ability for customers to upload documents from online channels (shown as “OLB” in the diagram); an ability to launch workflows in BPM from channels (e.g. mobile, tablet); ability for customers to see workflow status within channel applications; and automated workflow spanning front-office and product operations.

The diagram depicts a variety of services indicated by the following abbreviations: WIS (Workflow Initiation Service); WSS (Workflow Status Service); DS (Document Service); DES (Document Event Service); DSS (Document Set Service); DTS (Document Tracking Service); and CMIS (Content Management Interoperability Services).

In cases where business processes are automated by means of BPM-driven workflows, a “structured” approach can be taken to getting the required documents into the Digital Library, as depicted. For example, a customer completing an online application from a tablet, PC, etc. (a) for some product might, behind the scenes, give rise to new workflow in BPM (b). When documents are required, the workflow in BPM can submit a request for documents to be scanned (by an employee) or uploaded (by a customer), or possibly both. Employees can then scan documents (either internally generated or brought in by a customer) at a Multi-Function Printer (MFP) (c), and/or customers can upload documents from online channels. Either way, the documents are stored in the Digital Library (d). This process is referred to as “structured” document acquisition.

In cases where business processes are fluid, or not automated by BPM-driven workflows, an “informal” or ad hoc approach can be taken to sharing documents with, or obtaining documents from customers. This provides a second implementation of collaboration services (“Informal”/Ad Hoc Document Acquisition/Sharing).

For example, when sharing files with customers, using OneDrive, employees can share files with customers, and customers can then access those files via the Internet (by logging into OneDrive). When receiving files from customers, employees can share folders with customers, granting individual customers “write” access, allowing the customer to upload files into the shared folder in the employee's OneDrive account. Uploaded files are automatically “synced” to the employees work device(s) and can be accessed.

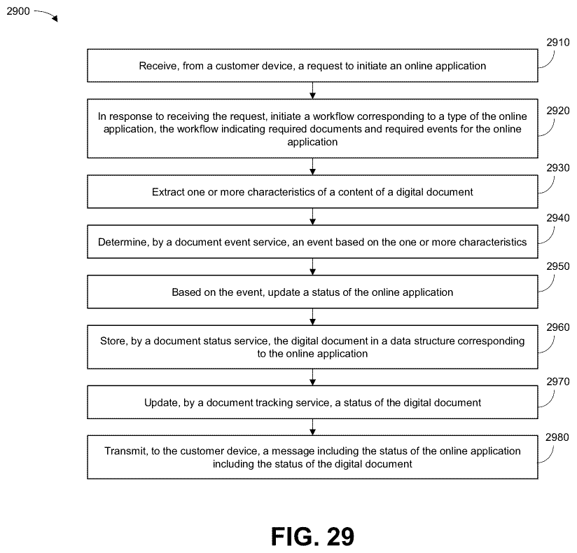

FIG. 29 illustrates a flow diagram of operations of a method 2900 for tracking digitized documents. The method 2900 may include more, fewer, or different operations than shown. The operations may be performed in the order shown, in a different order, or concurrently. The method 2900 may be performed by the system 1600 of FIG. 16.

At operation 2910, a request is received from a customer device to initiate an online application. The online application may be an application for a new checking account, or for a new mortgage account. The customer device may be a mobile phone, laptop, personal computer, or other computing device.

At operation 2920, in response to receiving the request, a workflow is initiated corresponding to a type of the online application, the workflow indicating required documents and required events for the online application. The workflow may be an open checking account workflow or an open mortgage account workflow, among other workflows. The required documents and events for the online application may indicate requirements for successfully completing the online application and/or for successfully completing the workflow. In an example, an open mortgage account workflow may indicate a proof-of-income document as a required document and loan document signing as a required event.

At operation 2930, one or more characteristics of a content of a digital document are extracted. The digital document may be a digitized (e.g., scanned) version of a physical document that was digitized using a multi-function printer integrated with a document digitization system. Extracting the one or more characteristics of the digital document may include recognizing the text (e.g., performing OCR) on the digital document and analyzing the extracted text (e.g., executing functionality described herein based on the extracted text).

At operation 2940, an event is determined based on the one or more characteristics by a document event service. The document event service may correlate the one or more characteristics to the required events of the workflow to determine the event.

At operation 2950, based on the event, a status of the online application is updated. The status of the online application may be updated to reflect the occurrence of the event. In an example, the status of the online application may be updated to reflect a signing of a document required for the online application. In this way, a customer can view the status of the online application using the customer device.

At operation 2960, the digital document is stored by a document status service in a data structure corresponding to the online application. The data structure may include a document package stored in a data hub. The data structure may include indications of the required documents and events indicated by the workflow as well as indications of the status of the required documents and events.

At operation 2970, a status of the digital document is updated by a document tracking service. In some implementations, document tracking service may track the events and/or monitor documents in the data structure corresponding to the online application. In some implementations, the document tracking service updates the status of the document in the data structure corresponding to the online application based on the determined event.

At operation 2980, a message is transmitted, to the customer device, including the status of the online application including the status of the digital document. The message may cause the status of the online application to be displayed to the user via a user interface. In an example, the message is an API call. In an example, the message is an email. In this way, the user interface can present for display to the customer which required documents have been provided and which required events have been accomplished.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

For simplicity only one computing device 2100 is shown in FIG. 2, but the respective systems may include more computing devices operable by users to access remote network resources and exchange data. The computing devices may be the same or different types of devices. The computing device includes at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A digitization service system comprising:
a non-transitory, computer-readable medium including instructions which, when executed by one or more processors, cause the one or more processors to:
receive, from a customer device, a request to initiate an online application;
in response to receiving the request, initiate a workflow corresponding to a type of the online application, the workflow indicating required documents and required events for the online application, the workflow comprising:
extract one or more characteristics of a content of a digital document;
determine, by a document event service, an event based on the one or more characteristics;
based on the event, update a status of the online application including the required documents for the online application;
store, by a document status service, the digital document in a data structure corresponding to the online application; and
update, by a document tracking service, a status of the digital document; and
transmit, to the customer device, a message including the status of the online application including the status of the digital document.

2. The system of claim 1, wherein the instructions further cause the one or more processors to extract the one or more characteristics of the content of the digital document using optical character recognition.

3. The system of claim 1, wherein the instructions further cause the one or more processors to request the digital document to be uploaded to a digital library.

4. The system of claim 3, wherein the instructions further cause the one or more processors to request the digital document to be uploaded to a digital library by requesting, via an integrated scanner, scanning of a physical document corresponding to the digital document.

5. The system of claim 4, wherein the instructions further cause the one or more processors to update a status of the digital document based on the scanning of the physical document corresponding to the digital document.

6. The system of claim 3, wherein the instructions further cause the one or more processors to request the digital document to be uploaded by the customer device.

7. The system of claim 1, wherein the event comprises a signing event.

8. A non-transitory, computer-readable medium including instructions which, when executed by one or more processors, cause the one or more processors to:
receive, from a customer device, a request to initiate an online application;
In response to receiving the request, initiate a workflow corresponding to a type of the online application, the workflow indicating required documents and required events for the online application, the workflow comprising:
extract one or more characteristics of a content of a digital document;
determine, by a document event service, an event based on the one or more characteristics;
based on the event, update a status of the online application including the required documents for the online application;
store, by a document status service, the digital document in a data structure corresponding to the online application; and
update, by a document tracking service, a status of the digital document; and
transmit, to the customer device, a message including the status of the online application including the status of the digital document.

9. The non-transitory, computer-readable medium of claim 8, wherein the instructions further cause the one or more processors to extract the one or more characteristics of the content of the digital document using optical character recognition.

10. The non-transitory, computer-readable medium of claim 8, wherein the instructions further cause the one or more processors to request the digital document to be uploaded to a digital library.

11. The non-transitory, computer-readable medium of claim 10, wherein the instructions further cause the one or more processors to request the digital document to be uploaded to a digital library by requesting, via an integrated scanner, scanning of a physical document corresponding to the digital document.

12. The non-transitory, computer-readable medium of claim 11, wherein the instructions further cause the one or more processors to update a status of the digital document based on the scanning of the physical document corresponding to the digital document.

13. The non-transitory, computer-readable medium of claim 10, wherein the instructions further cause the one or more processors to request the digital document to be uploaded by the customer device.

14. The non-transitory, computer-readable medium of claim 1, wherein the event comprises a signing event.

15. A method comprising:
receiving, from a customer device, a request to initiate an online application;
In response to receiving the request, initiate a workflow corresponding to a type of the online application, the workflow indicating required documents and
required events for the online application, the workflow comprising:
extracting one or more characteristics of a content of a digital document;
determining, by a document event service, an event based on the one or more characteristics;
based on the event, updating a status of the online application including the required documents for the online application;
storing, by a document status service, the digital document in a data structure corresponding to the online application; and
updating, by a document tracking service, a status of the digital document; and
transmitting, to the customer device, a message including the status of the online application including the status of the digital document.

16. The method of claim 15, wherein extracting the one or more characteristics of the content of the digital document includes performing optical character recognition.

17. The method of claim 15, further comprising requesting the digital document to be uploaded to a digital library.

18. The method of claim 17, further comprising requesting the digital document to be uploaded to the digital library by requesting, via an integrated scanner, scanning of a physical document corresponding to the digital document.

19. The method of claim 18, wherein the instructions further cause the one or more processors to update a status of the digital document based on the scanning of the physical document corresponding to the digital document.

20. The method of claim 17, wherein the instructions further cause the one or more processors to request the digital document to be uploaded by the customer device.
